(19) United States
(12) Patent Application Publication
(10) Pub. No.: US 2024/0340134 A1
(43) Pub. Date: Oct. 10, 2024

(54) ELECTRONIC DEVICE FOR TRANSMITTING REFERENCE SIGNAL AND METHOD FOR THE SAME

(71) Applicant: Samsung Electronics Co., Ltd., Suwon-si (KR)

(72) Inventors: Kyujae JANG, Suwon-si (KR); Hyeyong GO, Suwon-si (KR); Dohun KIM, Suwon-si (KR); Sungchul PARK, Suwon-si (KR); Hyoungtak SON, Suwon-si (KR); Jihyeon JANG, Suwon-si (KR); Woosik CHO, Suwon-si (KR)

(21) Appl. No.: 18/635,488

(22) Filed: Apr. 15, 2024

Related U.S. Application Data
(63) Continuation of application No. PCT/KR2024/003419, filed on Mar. 19, 2024.

(30) Foreign Application Priority Data
Apr. 6, 2023 (KR) 10-2023-0045357
May 15, 2023 (KR) 10-2023-0062361
Dec. 28, 2023 (KR) 10-2023-0195117

(51) Int. Cl. H04L 5/00; H04W 72/541

(52) U.S. Cl. CPC H04L 5/0048; H04L 5/0053; H04L 5/0094; H04W 72/541

(57) ABSTRACT

In an electronic device and operation method thereof according to various embodiments, the electronic device may include a plurality of antennas. The electronic device may include a communication circuit electrically connected to the plural antennas. The electronic device may include a communication processor, comprising at least one processor, comprising processing circuitry, operably connected to the communication circuit. At least one processor, individually and/or collectively, may be configured to control the electronic device to: receive information indicating a combination of frequency bands to be used for cellular communication from a cellular network; based on the combination of frequency bands being a combination of designated frequency bands, transmit, to the cellular network, user equipment (UE) capability information including information for changing an operation related to transmission of a reference signal in a first frequency band among the combination of frequency bands; receive, from the cellular network, a signal including parameters related to transmission of a reference signal configured based on the information for changing the operation related to transmission of a reference signal; and transmit a reference signal based on the parameters related to transmission of a reference signal.

### CROSS-REFERENCE TO RELATED APPLICATIONS

This application is a continuation of International Application No. PCT/KR2024/003419 designating the United States, filed on Mar. 19, 2024, in the Korean Intellectual Property Receiving Office, and claiming priority to Korean Patent Application Nos. 10-2023-0045357, filed on Apr. 6, 2023, 10-2023-0062361, filed on May 15, 2023, and 10-2023-0195117, filed on Dec. 28, 2023, in the Korean Intellectual Property Office, the disclosures of each of which are incorporated by reference herein in their entireties.

### BACKGROUND

### Field

The disclosure relates to an electronic device and operation method thereof and, for example, to an electronic device that transmits a reference signal.

### Description of Related Art

In order to meet the increase in the demand for wireless data traffic after the commercialization of 4G communication systems, considerable effort has been made to develop pre-5G communication systems or improved 5G communication systems. For this reason, “5G communication systems” or “pre-5G communication systems” are called “beyond 4G network communication systems” or “beyond LTE systems (post-LTE systems)”. In order to achieve a high data transmission rate, 5G communication systems are being developed to be implemented in an ultra-high frequency (mmWave) band (for example, a band of 6 GHz or higher) in addition to a band (a band of 6 GHz or lower) used in LTE systems. In 5G communication systems, technologies such as beamforming, massive MIMO, full dimensional MIMO (FD-MIMO), array antennas, analog beam-forming, and large-scale antennas have been discussed.

An electronic device may transmit a reference signal (e.g., sounding reference signal (SRS)) to a base station of a cellular network. The electronic device equipped with a plurality of antennas may transmit a reference signal to the base station through at least one antenna among the plural antennas in a manner set by the cellular network. The base station may perform channel estimation to estimate the state of the channel between the base station and the antenna having transmitted the reference signal based on the reference signal. The base station may allocate resources that can be used by the electronic device based on the channel state identified through channel estimation.

The above information is presented as background information only and to assist with an understanding of the disclosure. No determination has been made, and no assertion is made, as to whether any of the above might be applicable as prior art with regard to the disclosure.

Due to the limited size of the form factor of an electronic device, a sufficient distance between plural antennas may be not secured, and isolation between plural antennas may be not secured. If sufficient isolation between the plural antennas is not secured, the signal transmitted through one antenna may affect the performance of another antenna adjacent to the one antenna.

The electronic device may receive parameters related to transmission of a reference signal from a base station of a cellular network, and transmit a reference signal using a plurality of antennas based on the received parameters. The electronic device may control switches electrically connected to the antennas to change the antenna to be used to transmit a reference signal. However, as the electronic device changes the state of the switch to change the antenna to transmit a reference signal, the performance of another antenna adjacent to the antenna or switch transmitting the reference signal may be degraded.

The electronic device may receive a signal of a frequency band different from the frequency band used to transmit a reference signal through a different antenna, but the quality of the signal received through the different frequency band may be lowered due to the transmission of the reference signal. The electronic device may transmit a signal (e.g., measurement report) indicating poor quality to the base station, and the base station having identified the signal quality may allocate relatively low-performance resources to the electronic device. The electronic device may implement relatively low transmission or reception speeds, and the quality of services using cellular communication may deteriorate.

The technical objectives to be achieved in this document are not limited to those mentioned above, and other technical objectives not mentioned will be clearly understood by those skilled in the art to which the disclosure belongs from the following description.

### SUMMARY

An electronic device according to an example embodiment may include a plurality of antennas. The electronic device may include a communication circuit that is electrically connected to the plural antennas. The electronic device may include at least one communication processor comprising processing circuitry, operably connected to the communication circuit. At least one communication processor, individually and/or collectively, may be configured to control the electronic device to: receive information indicating a combination of frequency bands to be used for cellular communication from a cellular network; based on the combination of frequency bands being a combination of designated frequency bands, transmit, to the cellular network, user equipment (UE) capability information including information for changing an operation related to transmission of a reference signal in a first frequency band among the combination of frequency bands; receive, from the cellular network, a signal including parameters related to transmission of a reference signal configured based on the information for changing the operation related to transmission of a reference signal; and transmit a reference signal based on the parameters related to transmission of a reference signal.

A method of operating an electronic device according to an example embodiment may include: receiving information indicating a combination of frequency bands to be used for cellular communication from a cellular network; based on the combination of frequency bands being a combination of designated frequency bands, transmitting, to the cellular network, user equipment (UE) capability information including information for changing an operation related to transmission of a reference signal in a first frequency band among the combination of frequency bands; receiving, from the cellular network, a signal including parameters related to transmission of a reference signal configured based on the information for changing the operation related to transmission of a reference signal; and transmitting a reference signal based on the parameters related to transmission of a reference signal.

An electronic device according to an example embodiment may include a plurality of antennas. The electronic device may include at least one communication processor comprising processing circuitry, operably connected to the plural antennas. At least one communication processor, individually and/or collectively, may be configured to control the electronic device to: receive information indicating a first frequency band and a second frequency band from a cellular network; based on transmitting a reference signal through the first frequency band using at least some of the plural antennas, one check whether there is an error in data included in a signal of the second frequency band received through another antenna; based on there being an error in the data, one perform operations to release a connection with the cellular network through the first frequency band; receive a user equipment (UE) capability inquiry message from the cellular network while connecting again to the cellular network through the first frequency band; and transmit UE capability information including information for changing an operation related to transmission of a reference signal to the cellular network.

In the electronic device and operation method thereof according to various example embodiments, when data transmission or reception is performed through a combination of specific frequency bands, UE capability information including information for changing operations related to transmission of a reference signal in a specific frequency band may be transmitted to the cellular network. The electronic device may configure information to change operations related to the transmission of a reference signal in a specific frequency band to maintain reception performance of signals in other frequency bands affected by the transmission of the reference signal, which can prevent and/or reduce a decrease in data transmission speed or reception speed through different frequency bands due to the transmission of the reference signal.

The effects that can be obtained from the disclosure are not limited to those mentioned above, and other effects not mentioned may be clearly understood by those skilled in the art to which the disclosure belongs from the following description.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device according to various embodiments;

FIG. 2 is a block diagram illustrating an example configuration of an electronic device for supporting legacy network communication and 5G network communication according to various embodiments;

FIG. 3 is a diagram illustrating the structure of a protocol stack in a network for legacy communication and/or 5G communication according to various embodiments;

FIG. 4A is a diagram illustrating an electronic device and a cellular network according to various embodiments;

FIG. 4B is a block diagram illustrating an example configuration of an electronic device according to various embodiments;

FIG. 5 is a block diagram illustrating an example configuration of an electronic device according to various embodiments;

FIG. 6 is a diagram illustrating an electronic device that outputs a reference signal in a first operation mode according to various embodiments;

FIG. 7 is a signal flow diagram illustrating an example operation of an electronic device that transmits UE capability information according to various embodiments;

FIG. 8 is a flowchart illustrating an example method of operating the electronic device according to various embodiments;

FIG. 9 is a flowchart illustrating an example method of operating the electronic device according to various embodiments;

FIG. 10 is a block diagram illustrating an example configuration of an electronic device according to various embodiments;

FIG. 11 is a flowchart illustrating an example method of operating an electronic device according to various embodiments; and

FIG. 12 is a flowchart illustrating an example method of operating an electronic device according to various embodiments.

### DETAILED DESCRIPTION

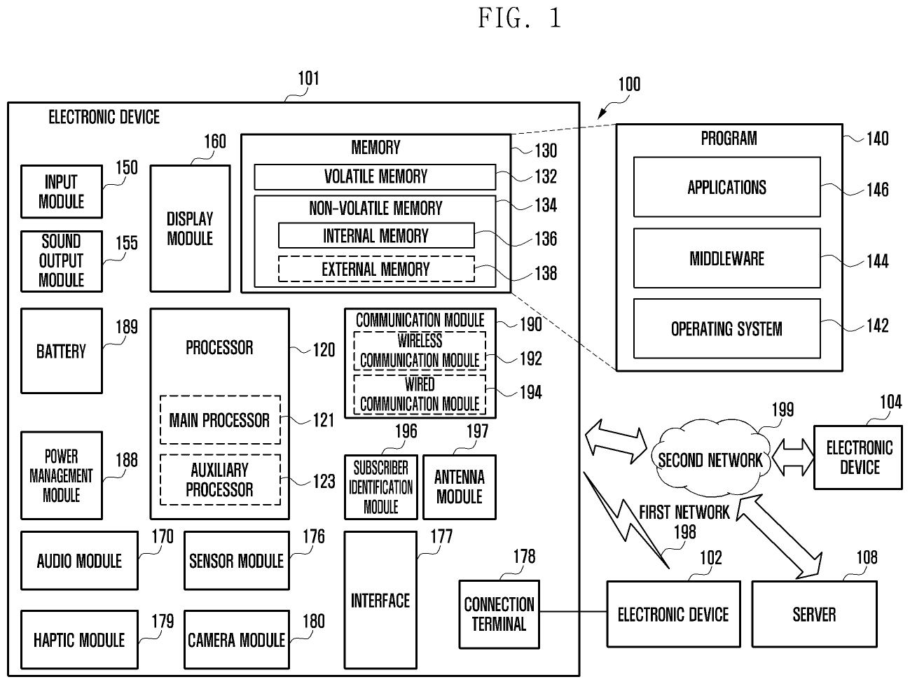

FIG. 1 is a block diagram illustrating an example electronic device in a network environment according to various embodiments. Referring to FIG. 1, an electronic device 101 in a network environment 100 may communicate with an electronic device 102 via a first network 198 (e.g., a short-range wireless communication network), or an electronic device 104 or a server 108 via a second network 199 (e.g., a long-range wireless communication network). According to an embodiment of the disclosure, the electronic device 101 may communicate with the electronic device 104 via the server 108. According to an embodiment of the disclosure, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In various embodiments of the disclosure, at least one (e.g., the display device 160 or the camera module 180) of the components may be omitted from the electronic device 101, or one or more other components may be added in the electronic device 101. In various embodiments of the disclosure, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment of the disclosure, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment of the disclosure, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment of the disclosure, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment of the disclosure, all or some of operations to be executed at the electronic device 101 may be executed at one or more of the external electronic devices 102 or 104. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

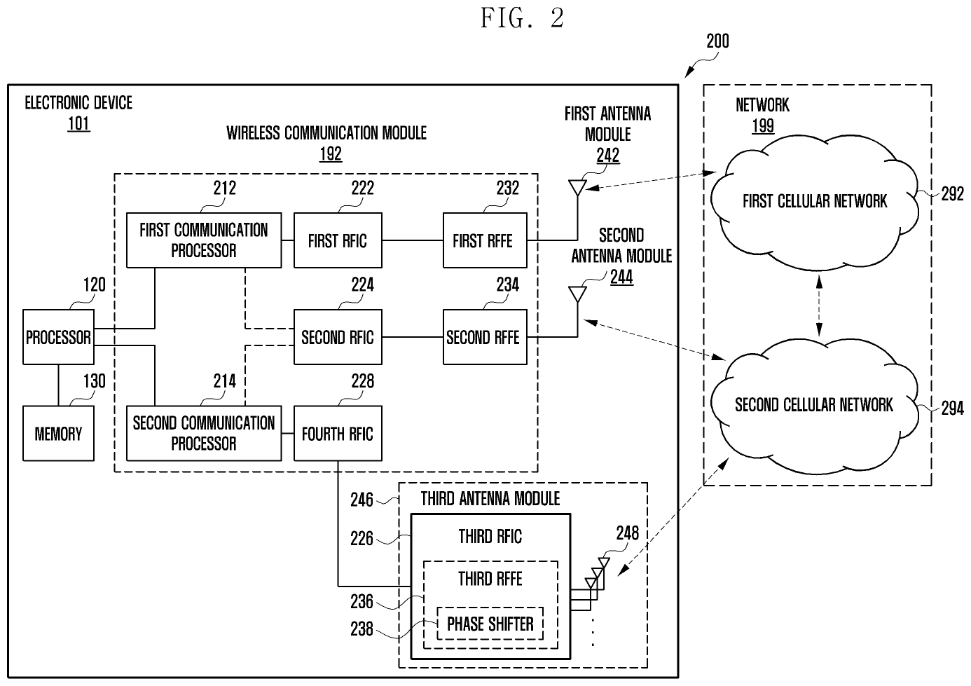

FIG. 2 is a block diagram 200 illustrating an example configuration of an electronic device 101 for supporting legacy network communication and 5G network communication according to various embodiments. Referring to FIG. 2, the electronic device 101 may include a first communication processor (e.g., including processing circuitry) 212, a second communication processor (e.g., including processing circuitry) 214, a first radio frequency integrated circuit (RFIC) 222, a second RFIC 224, a third RFIC 226, a fourth RFIC 228, a first radio frequency front end (RFFE) 232, a second RFFE 234, a first antenna module (e.g., including at least one antenna) 242, a second antenna module (e.g., including at least one antenna) 244, and an antenna 248. The electronic device 101 may further include the processor (e.g., including processing circuitry) 120 and the memory 130. The network 199 may include a first network 292 and a second network 294. According to an embodiment of the disclosure, the electronic device 101 may further include at least one component among the components illustrated in FIG. 1, and the network 199 may further include at least one other network. According to an embodiment of the disclosure, the first communication processor 212, the second communication processor 214, the first RFIC 222, the second RFIC 224, the fourth RFIC 228, the first RFFE 232, and the second RFFE 234 may be included as at least a part of the wireless communication module 192. According to an embodiment of the disclosure, the fourth RFIC 228 may be omitted or may be included as a part of the third RFIC 226.

The first communication processor 212 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The communication processor 212 may establish a communication channel of a band to be used for wireless communication with the first network 292, and may support legacy network communication via the established communication channel. According to certain embodiments of the disclosure, the first network may be a legacy network including 2G, 3G, 4G, or long term evolution (LTE) network. The second communication processor 214 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The second communication processor 214 may establish a communication channel corresponding to a designated band (e.g., approximately 6 GHz to 60 GHz) among bands to be used for wireless communication with the second network 294, and may support 5G network communication via the established channel. According to certain embodiments of the disclosure, the second network 294 may be a 5G network defined in 3GPP. Additionally, according to an embodiment of the disclosure, the first communication processor 212 or the second communication processor 214 may establish a communication channel corresponding to another designated band (e.g., lower than 6 GHz) among bands to be used for wireless communication with the second network 294, and may support 5G network communication via the established channel. According to an embodiment of the disclosure, the first communication processor 212 and the second communication processor 214 may be implemented in a single chip or a single package. According to certain embodiments of the disclosure, the first communication processor 212 or the second communication processor 214 may be implemented in a single chip or a single package, together with the processor 120, the auxiliary processor 123, or the communication module 190.

In the case of transmission, the first RFIC 222 may convert a baseband signal generated by the first communication processor 212 into a radio frequency (RF) signal in a range of approximately 700 MHz to 3 GHz used for the first network 292 (e.g., a legacy network). In the case of reception, an RF signal is obtained from the first network 292 (e.g., a legacy network) via an antenna (e.g., the first antenna module 242), and may be preprocessed via an RFFE (e.g., the first RFFE 232). The first RFIC 222 may convert the preprocessed RF signal to a baseband signal so that the base band signal is processed by the first communication processor 212.

In the case of transmission, the second RFIC 224 may convert a baseband signal generated by the first communication processor 212 or the second communication processor 214 into an RF signal (hereinafter, a 5G Sub6 RF signal) of a Sub6 band (e.g., lower than 6 GHz) used for the second network 294 (e.g., 5G network). In the case of reception, a 5G Sub6 RF signal is obtained from the second network 294 (e.g., a 5G network) via an antenna (e.g., the second antenna module 244), and may preprocessed by an RFFE (e.g., the second RFFE 234). The second RFIC 224 may convert the preprocessed 5G Sub6 RF signal into a baseband signal so that the baseband signal is processed by a corresponding communication processor from among the first communication processor 212 or the second communication processor 214.

The third RFIC 226 may convert a baseband signal generated by the second communication processor 214 into an RF signal (hereinafter, a 5G Above6 RF signal) of a 5G Above6 band (e.g., approximately 6 GHz to 60 GHz) to be used for the second network 294 (e.g., 5G network). In the case of reception, a 5G Above6 RF signal is obtained from the second network 294 (e.g., a 5G network) via an antenna (e.g., the antenna 248), and may be preprocessed by the third RFFE 236. The third RFIC 226 may convert the preprocessed 5G Above6 RF signal to a baseband signal so that the base band signal is processed by the second communication processor 214. According to an embodiment of the disclosure, the third RFFE 236 may be implemented as a part of the third RFIC 226.

According to an embodiment of the disclosure, the electronic device 101 may include the fourth RFIC 228, separately from or as a part of the third RFIC 226. In this instance, the fourth RFIC 228 may convert a baseband signal generated by the second communication processor 214 into an RF signal (hereinafter, an IF signal) in an intermediate frequency band (e.g., approximately 9 GHz to 11 GHz), and may transfer the IF signal to the third RFIC 226. The third RFIC 226 may convert the IF signal to a 5G Above6 RF signal. In the case of reception, a 5GAbove6 RF signal is received from the second network 294 (e.g., a 5G network) via an antenna (e.g., the antenna 248), and may be converted into an IF signal by the third RFFE 226. The fourth RFIC 228 may convert the IF signal to a baseband signal so that the base band signal is processed by the second communication processor 214.

According to an embodiment of the disclosure, the first RFIC 222 and the second RFIC 224 may be implemented as a single chip or at least a part of the single package. According to an embodiment of the disclosure, the first RFFE 232 and the second RFFE 234 may be implemented as a single chip or at least a part of the single package. According to an embodiment of the disclosure, at least one antenna module of the first antenna module 242 or the second antenna module 244 may be omitted, or may be combined with another antenna module so as to process RF signals in a plurality of bands.

According to an embodiment of the disclosure, the third RFIC 226 and the antenna 248 may be disposed in the same substrate, and may form the third antenna module 246. For example, the wireless communication module 192 or the processor 120 may be disposed in a first substrate (e.g., main PCB). In this instance, the third RFIC 226 is disposed in a part (e.g., a lower part) of the second substrate (e.g., a sub PCB) separate from the first substrate and the antenna 248 is disposed on another part (e.g., an upper part), so that the third antenna module 246 is formed. By disposing the third RFIC 226 and the antenna 248 in the same substrate, the length of a transmission line therebetween may be reduced. For example, this may reduce a loss (e.g., attenuation) of a signal in a high-frequency band (e.g., approximate 6 GHz to 60 GHz) used for 5G network communication, the loss being caused by a transmission line. Accordingly, the electronic device 101 may improve the quality or speed of communication with the second network 294 (e.g., 5G network).

According to an embodiment of the disclosure, the antenna 248 may be implemented as an antenna array including a plurality of antenna elements which may be used for beamforming. In this instance, the third RFIC 226 may be, for example, a part of the third RFFE 236, and may include a plurality of phase shifters 238 corresponding to a plurality of antenna elements. In the case of transmission, each of the plurality of phase shifters 238 may shift the phase of a 5G Above6RF signal to be transmitted to the outside of the electronic device 101 (e.g., a base station of a 5G network) via a corresponding antenna element. In the case of reception, each of the plurality of phase shifters 238 may shift the phase of the 5GAbove6 RF signal received from the outside via a corresponding antenna element into the same or substantially the same phase. This may enable transmission or reception via beamforming between the electronic device 101 and the outside.

The second network 294 (e.g., 5G network) may operate independently (e.g., Stand-Along (SA)) from the first network 292 (e.g., a legacy network), or may operate by being connected thereto (e.g., Non-Stand Alone (NSA)). For example, in the 5G network, only an access network (e.g., 5G radio access network (RAN) or next generation RAN (NG RAN)) may exist, and a core network (e.g., next generation core (NGC)) may not exist. In this instance, the electronic device 101 may access an access network of the 5G network, and may access an external network (e.g., the Internet) under the control of the core network (e.g., an evolved packed core (EPC)) of the legacy network. Protocol information (e.g., LTE protocol information) for communication with the legacy network or protocol information (e.g., New Radio (NR) protocol information) for communication with the 5G network may be stored in the memory 230, and may be accessed by another component (e.g., the processor 120, the first communication processor 212, or the second communication processor 214).

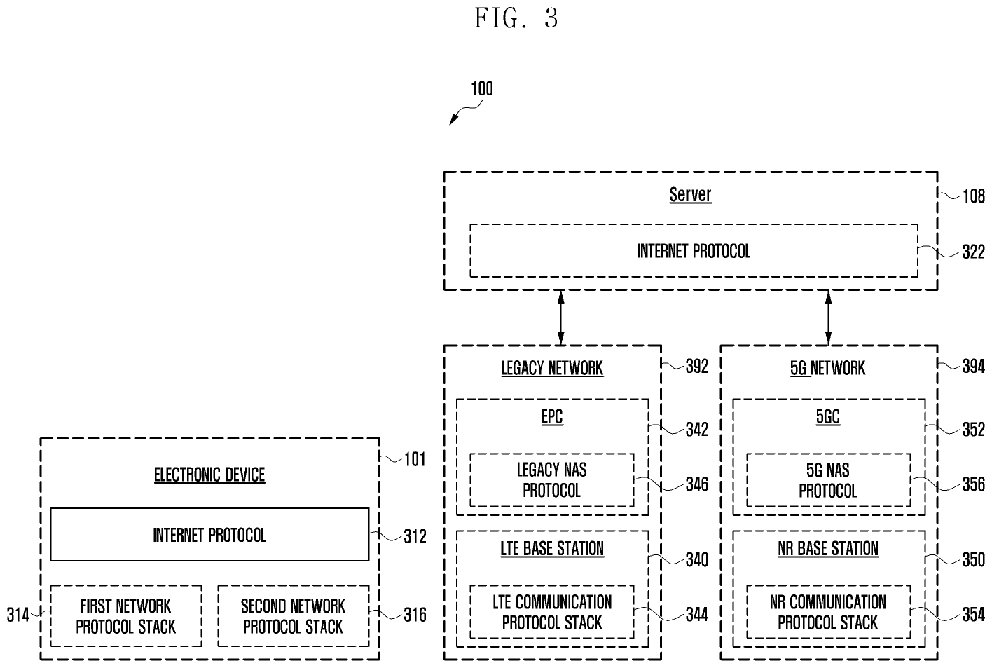

FIG. 3 is a diagram illustrating a protocol stack structure of the network 100 of legacy communication and/or 5G communication according to various embodiments.

Referring to FIG. 3, the network 100 according to an illustrated embodiment may include the electronic device 101, a legacy network 392, a 5G network 394, and the server 108.

The electronic device 101 may include an Internet protocol 312, a first communication protocol stack 314, and a second communication protocol stack 316. The electronic device 101 may communicate with the server 108 through the legacy network 392 and/or the 5G network 394.

According to an embodiment of the disclosure, the electronic device 101 may perform Internet communication associated with the server 108 through the Internet protocol 312 (for example, a transmission control protocol (TCP), a user datagram protocol (UDP), or an internet protocol (IP)). The Internet protocol 312 may be executed by, for example, a main processor (for example, the main processor 121 of FIG. 1) included in the electronic device 101.

According to an embodiment of the disclosure, the electronic device 101 may perform wireless communication with the legacy network 392 through the first communication protocol stack 314. According to an embodiment of the disclosure, the electronic device 101 may perform wireless communication with the 5G network 394 through the second communication protocol stack 316. The first communication protocol stack 314 and the second communication protocol stack 316 may be executed by, for example, one or more communication processors (for example, the wireless communication module 192 of FIG. 1) included in the electronic device 101.

The server 108 may include an Internet protocol 322. The server 108 may transmit and receive data related to the Internet protocol 322 to and from the electronic device 101 through the legacy network 392 and/or the 5G network 394. According to an embodiment of the disclosure, the server 108 may include a cloud computing server existing outside the legacy network 392 or the 5G network 394. According to an embodiment of the disclosure, the server 108 may include an edge computing server (or a mobile edge computing (MEC) server) located inside at least one of the legacy network or the 5G network 394.

The legacy network 392 may include an LTE eNode B (eNB) 340 and an EPC 342. The LTE eNB 340 may include an LTE communication protocol stack 344. The EPC 342 may include a legacy NAS protocol 346. The legacy network 392 may perform LTE wireless communication with the electronic device 101 through the LTE communication protocol stack 344 and the legacy NAS protocol 346.

The 5G network 394 may include an NR gNB 350 and a 5GC 352. The NR gNB 350 may include an NR communication protocol stack 354. The 5GC 352 may include a 5G NAS protocol 356. The 5G network 394 may perform NR wireless communication with the electronic device 101 through the NR communication protocol stack 354 and the 5G NAS protocol 356.

According to an embodiment of the disclosure, the first communication protocol stack 314, the second communication protocol stack 316, the LTE communication protocol stack 344, and the NR communication protocol stack 354 may include a control plane protocol for transmitting and receiving a control message and a user plane protocol for transmitting and receiving user data. The control message may include a message related to at least one of, for example, security control, bearer setup, authentication, registration, or mobility management. The user data may include, for example, the remaining data except other than the control message.

According to an embodiment of the disclosure, the control plane protocol and the user plane protocol may include a physical (PHY) layer, a medium access control (MAC) layer, a radio link control (RLC) layer, or a packet data convergence protocol (PDCP) layer. The PHY layer may channel-code and modulate data received from, for example, a higher layer (for example, the MAC layer), transmit the data through a radio channel, demodulate and decode the data received through the radio channel, and transmit the data to the higher layer. The PHY layer included in the second communication protocol stack 316 and the NR communication protocol stack 354 may further perform an operation related to beamforming. The MAC layer may logically/physically map, for example, data to a radio channel for transmitting and receiving the data and perform a hybrid automatic repeat request (HARQ) for error correction. The RLC layer may perform, for example, data concatenation, segmentation, or reassembly, and data sequence identification, reordering, or duplication detection. The PDCP layer may perform an operation related to, for example, ciphering of a control message and user data and data integrity. The second communication protocol stack 316 and the NR communication protocol stack 354 may further include a service data adaptation protocol (SDAP). The SDAP may manage allocation of radio bearers on the basis of quality of service (QoS) of user data.

According to certain embodiments of the disclosure, the control plane protocol may include a radio resource control (RRC) layer and a non-access stratum (NAS) layer. The RRC layer may process control, for example, data related to radio bearer setup, paging, or mobility management. The NAS may process, for example, a control message related to authentication, registration, or mobility management.

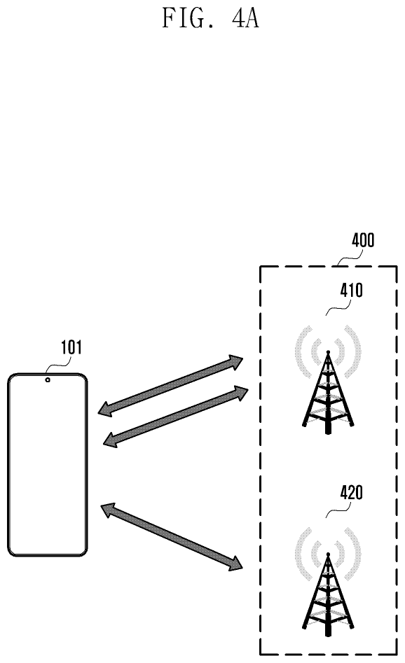

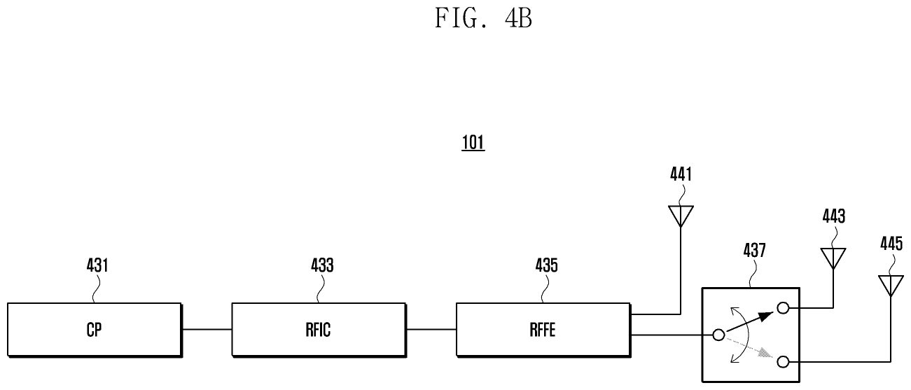

FIG. 4A is a diagram illustrating an electronic device and a cellular network according to various embodiments.

The cellular network 400 may include a first node 410 and a second node 420.

The first node 410 may include a base station supporting first cellular communication. The first cellular communication may be one of various cellular communication schemes that can be supported by the electronic device (e.g., electronic device 101 in FIG. 1), and may refer to, for example, a communication scheme on the second network 294 in FIG. 2. For example, the first cellular communication may be a communication scheme using 5^{th} generation mobile communication (e.g., new radio (NR)).

The first node 410 may transmit or receive a signal of a first frequency band supported by first cellular communication. When the electronic device 101 is connected to the cellular network 400 through the first node 410, it may perform data communication using a signal of the frequency band supported by the first node 410.

The first node 410 may support time division duplexing (TDD) supported by first cellular communication. When the first node 410 supports TDD, the electronic device 101 may transmit a signal to the first node 410 for a specified time and receive a signal from the first node 410 for another time. To identify the characteristics of the uplink band (e.g., quality of the uplink band), the first node 410 supporting TDD may command (or, request) the electronic device 101 to transmit a reference signal (e.g., sounding reference signal (SRS)).

For the electronic device 101 to transmit a reference signal, the first node 410 may transmit a signal (e.g., RRC reconfiguration message) including parameters related to the reference signal to the electronic device 101. The parameters related to a reference signal may refer to various parameters such as the transmission point of the reference signal (e.g., information on a slot allowing transmission of the reference signal) and the transmission periodicity of the reference signal.

The electronic device 101 may receive a signal including parameters related to a reference signal and transmit a reference signal to the first node 410 using the parameters related to the reference signal. The first node 410 may receive the reference signal, and may allocate resources (e.g., MCS level) required for the electronic device 101 to transmit a signal through a series of operations (e.g., channel estimation) using information contained in the reference signal. The electronic device 101 may transmit a signal to the first node 410 using resources allocated by the first node 410 (or, cellular network 400).

The second node 420 may include a base station that supports first cellular communication or second cellular communication. The second cellular communication may be one of various cellular communication schemes that can be supported by the electronic device 101, and may refer to, for example, a communication scheme on the first network 292 in FIG. 2. For example, the second cellular communication may be a communication scheme using 4^{th} generation mobile communication (e.g., long term evolution (LTE)).

The second node 420 may transmit or receive a signal of a second frequency band supported by first cellular communication or second cellular communication. When the electronic device 101 is connected to the cellular network 400 through the second node 420, it may perform data communication using a signal of the second frequency band supported by the second node 420.

The second node 420 may support frequency division duplexing (FDD) supported by first cellular communication or second cellular communication. When the first node 410 supports FDD, the electronic device 101 may transmit a signal to the second node 420 over a frequency band assigned to data transmission, and may receive a signal from the second node 420 over another frequency band assigned to data reception.

For the electronic device 101 to transmit a reference signal, the second node 420 may transmit a signal (e.g., RRC reconfiguration message) including parameters related to the reference signal to the electronic device 101. The parameters related to a reference signal may refer to various parameters such as the transmission point of the reference signal (e.g., information on a slot allowing transmission of the reference signal) and the transmission periodicity of the reference signal.

The electronic device 101 may receive a signal including parameters related to a reference signal and transmit a reference signal to the second node 420 using the parameters related to the reference signal. The second node 420 may receive the reference signal, and may allocate resources (e.g., MCS level) required for the electronic device 101 to transmit a signal through a series of operations (e.g., channel estimation) using information contained in the reference signal. The electronic device 101 may transmit a signal to the second node 420 using resources allocated by the second node 420 (or, cellular network 400).

The electronic device 101 may be connected to both the first node 410 and/or the second node 420 to transmit or receive data through the first node 410 and/or the second node 420. According to one example, while transmitting or receiving data to or from the first node 410 through resources allocated by the first node 410, the electronic device 101 may transmit or receive data to or from the second node 420 through resources allocated by the second node 420. Through the above method, the electronic device 101 can implement a higher transmission or reception rate compared to transmitting or receiving data through one node.

FIG. 4B is a block diagram illustrating an example configuration of an electronic device according to various embodiments.

With reference to FIG. 4B, the electronic device (e.g., electronic device 101 in FIG. 1) may include a communication processor (e.g., including processing circuitry) 431 (e.g., first communication processor 212 or second communication processor 214 in FIG. 2), an RFIC 433 (e.g., first RFIC 222, second RFIC 224, fourth RFIC 228 in FIG. 2), an RFFE 435 (e.g., first RFFE 232, second RFFE 234 in FIG. 2), a switch 437, and a plurality of antennas 441, 443, 445 (e.g., first antenna module 242, second antenna module 244, antenna 248 in FIG. 2).

The communication processor 431 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The communication processor 431 may receive or transmit control data or user data through short-range wireless communication (e.g., Wi-Fi or Bluetooth) or cellular wireless communication (e.g., 4^{th} generation mobile communication or 5^{th} generation mobile communication). The communication processor 431 may establish a cellular communication connection with a base station based on control data, and may transmit data received from an application processor (e.g., processor 120 in FIG. 1) to the base station through established cellular communication or transfer data received from the base station to the application processor 120.

The RFIC 433 may perform various operations to process signals received from the communication processor 431. According to an embodiment, the RFIC 433 may perform a modulation operation on a signal received from the communication processor 431. For example, the RFIC 433 may perform a frequency modulation operation to convert a baseband signal into a radio frequency (RF) signal used for cellular communication. The RFIC 433 may perform an operation to convert the phase of a signal according to a specified modulation scheme. The RFIC 433 may perform a demodulation operation on a signal received from the outside through the plural antennas 441, 443, 445. For example, the RFIC 433 may perform a frequency demodulation operation to convert a radio frequency (RF) signal into a baseband signal. The RFIC 433 may perform an operation to convert the phase of a signal according to a specified modulation scheme.

The RFFE 435 may receive signals radiated from the outside through the plural antennas 441, 443, 445, or may radiate signals transmitted from the RFIC 433 through the plural antennas 441, 443, 445. The RFFE 435 may include various components (e.g., amplifier, switch, filter, and/or coupler) to perform the operation of amplifying a signal received through the plural antennas 441, 443, 445 and/or a signal transmitted from the RFIC 433, and processing the amplified signals.

The communication processor 431 may be connected to both a first node (e.g., first node 410 in FIG. 4A) and/or a second node (e.g., second node 420 in FIG. 4A) and may transmit or receive data through the first node 410 and/or the second node 420. According to one example, while transmitting or receiving data to or from the first node 410 through resources allocated by the first node 410, the electronic device 101 may transmit or receive data to or from the second node 420 through resources allocated by the second node 420. For convenience of description, it is assumed that the communication processor 431 receives a signal transmitted by the second node 420 through the first antenna 441, and receives a signal transmitted by the first node 410 through the second antenna 443 and/or the third antenna 445.

For the electronic device 101 to transmit a reference signal, the communication processor 431 may receive a signal (e.g., RRC reconfiguration message) containing parameters related to a reference signal from the first node (e.g., first node 410 in FIG. 4A). The communication processor 431 may transmit a reference signal to the first node 410 using the parameters related to the reference signal.

The communication processor 431 may use at least one antenna among the plural antennas 441, 443, 445 to transmit a reference signal. According to one example, while receiving a signal through the first antenna 441, the communication processor 431 may transmit a reference signal through the second antenna 443 at a transmission point for the reference signal indicated by the parameters related to the reference signal, and transmit a reference signal through the third antenna 445 at another transmission point for the reference signal indicated by the parameters related to the reference signal.

The communication processor 431 may control the switch 437 to electrically connect the RFFE 435 and the second antenna 443 in order to transmit a reference signal through the second antenna 443, and may control the switch 437 to electrically connect the RFFE 435 and the third antenna 445 in order to transmit a reference signal through the third antenna 445. As described above, the state of the switch 437 may change as the antenna to transmit a reference signal changes. A change in the state of the switch 437 may cause a change in the impedance of the first antenna 441, which may change the impedance of the first antenna 441 to an impedance other than the impedance appropriate for the first antenna 441 to receive a signal, thereby causing the quality of a signal received through the first antenna 441 to deteriorate.

According to one example, when the quality of the signal received through the first antenna 441 deteriorates, the error rate (e.g., block error rate (BLER)) of data included in the signal received through the first antenna 441 may increase. The communication processor 431 may transmit information indicating the error rate of data to the second node 420, and the second node 420 may allocate relatively low-performance resources for transmission or reception through the second frequency band in consideration of the error rate of data. The transmission or reception speed of data through the second node 420 may be lowered.

A description will be given of a specific example for reducing a phenomenon that occurs as transmission of a reference signal through a specific frequency band causes degradation of the quality of a signal transmitted through another frequency band with reference to the FIGS. below.

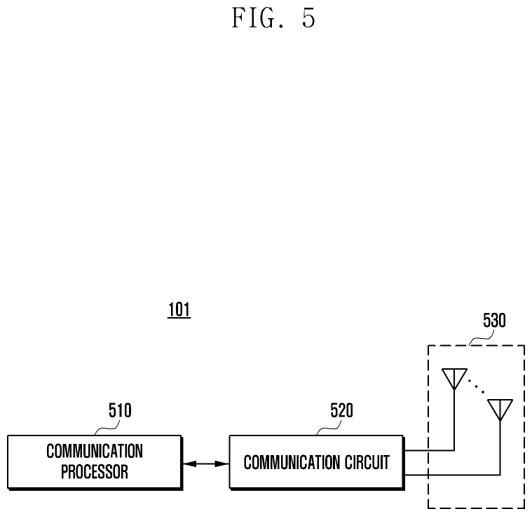

FIG. 5 is a block diagram illustrating an example configuration of an electronic device according to various embodiments.

With reference to FIG. 5, the electronic device (e.g., electronic device 101 in FIG. 1) may include a communication processor (e.g., including processing circuitry) 510 (e.g., processor 120 in FIG. 1, first communication processor 212 and/or second communication processor 214 in FIG. 2), a communication circuit 520 (e.g., wireless communication module 192 in FIG. 1), and/or a plurality of antennas 530 (e.g., first antenna 441, second antenna 443, third antenna 445 in FIG. 4B).

The communication circuit 520 may include a communication circuit that supports first cellular communication and/or second cellular communication, and may enable the electronic device 101 to communicate with an external electronic device (e.g., electronic device 104 in FIG. 1) through first cellular communication and/or second cellular communication.

The communication circuit 520 may include an RFIC (e.g., RFIC 433 in FIG. 4B) and/or one or more RFFEs (e.g., RFFE 435 in FIG. 4B).

The communication circuit 520 may support standalone mode and/or non-standalone mode of first cellular communication. In non-standalone mode of first cellular communication, the communication circuit 520 may be configured to communicate with an external electronic device 104 through a node (e.g., first node 410) supporting first cellular communication and/or a node (e.g., second node 420) supporting second cellular communication.

The communication circuit 520 may support carrier aggregation in standalone mode of first cellular communication. When supporting carrier aggregation of first cellular communication, the communication circuit 510 may be configured to communicate with an external electronic device 104 through the first node 410 and the second node 420.

The communication processor 510 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The communication processor 510 may be operably connected to the communication circuit 520. The processor 510 may control the components of the electronic device 101. For example, the processor 510 may control the components of the electronic device 101 according to one or more instructions stored in a memory (e.g., memory 130 in FIG. 1).

The communication processor 510 may perform data transmission and/or reception through first cellular communication and/or second cellular communication. The communication processor 510 may be connected to the first node 410 and/or the second node 420. The communication processor 510 may transmit user data received from the application processor (e.g., processor 120 in FIG. 1) through first cellular communication and/or second cellular communication, and may transfer user data received through first cellular communication and/or second cellular communication to the application processor 120.

The first cellular communication may be one of various cellular communication schemes that can be supported by the electronic device 101, and may refer to, for example, a communication scheme on the second network 294 in FIG. 2. For example, the first cellular communication may be a communication scheme using 5^{th} generation mobile communication (e.g., new radio).

The second cellular communication may be one of various cellular communication schemes that can be supported by the electronic device (e.g., electronic device 101 in FIG. 1), and may refer to, for example, a communication scheme on the first network 292 in FIG. 2. For example, the second cellular communication may be a communication scheme using 4^{th} generation mobile communication (e.g., long term evolution).

The communication processor 510 may be connected to the cellular network 400 through the first node 410 and may be connected to the cellular network 400 through the second node 420. The communication processor 510 may be connected to both the first node (e.g., first node 410 in FIG. 4A) and/or the second node (e.g., second node 420 in FIG. 4A), and may transmit or receive data through the first node 410 and/or the second node 420. While transmitting or receiving data to or from the first node 410 through resources allocated by the first node 410, the communication processor 510 may transmit or receive data to or from the second node 420 through resources allocated by the second node 420.

According to one example, while the communication processor 510 is connected to the cellular network 400 via the first node 410 and the second node 420, it may receive information indicating a combination of frequency bands to be used for cellular communication from the cellular network 400. The information indicating a combination of frequency bands to be used for cellular communication may be included in an RRC reconfiguration message or UE capability inquiry message received by the electronic device 101 in the process of being attached to the cellular network 400.

According to one example, the communication processor 510 may receive various signals (e.g., UE capability inquiry message, RRC reconfiguration message) in the process of attaching to the cellular network 400. The communication processor 510 may complete the connection procedure with the first node 410 and/or the second node 420 using the information indicating a combination of frequency bands. According to one example, the communication processor 510 may receive a signal including information indicating a combination of a first frequency band and a second frequency band, and may be connected to the first node 410 through the first frequency band and may be connected to the second node 420 through the second frequency band.

The communication processor 510 may identify whether the combination of frequency bands included in the information indicating a combination of frequency bands is a combination of designated frequency bands.

A combination of designated frequency bands may refer, for example, to a combination of a frequency band of a reference signal and a frequency band of a reception signal that receives interference from transmission of the reference signal. According to one example, the combination of designated frequency bands may include a combination of a first frequency band to transmit a reference signal and a second frequency band that receives interference from transmission of the reference signal.

The communication processor 510 may identify that the combination of frequency bands included in the information indicating a combination of frequency bands is a combination of designated frequency bands, and may transmit UE capability information including parameters related to transmission of a reference signal of the first frequency band among the combination of frequency bands. The communication processor 510 may identify that the combination of frequency bands included in the information indicating a combination of frequency bands is a combination of designated frequency bands, and may transmit, to the cellular network 400, UE capability information including information for changing the operation related to transmission of a reference signal of the first frequency band among the combination of frequency bands.

Changing the operation related to transmission of a reference signal of the first frequency band may refer to various operations for preventing and/or reducing the quality of a signal of the second frequency band from being deteriorated due to transmission of the reference signal in the first frequency band.

According to one example, changing the operation related to transmission of a reference signal in the first frequency band may include changing the operation mode of antenna switching for transmission of the reference signal.

Antenna switching may refer to changing the antenna for transmitting a reference signal. According to one example, the communication processor 510 supporting antenna switching may transmit a reference signal to the cellular network 400 through the second antenna 433 at a specific time, and may transmit a reference signal to the cellular network 400 through the third antenna 435 at another specific time.

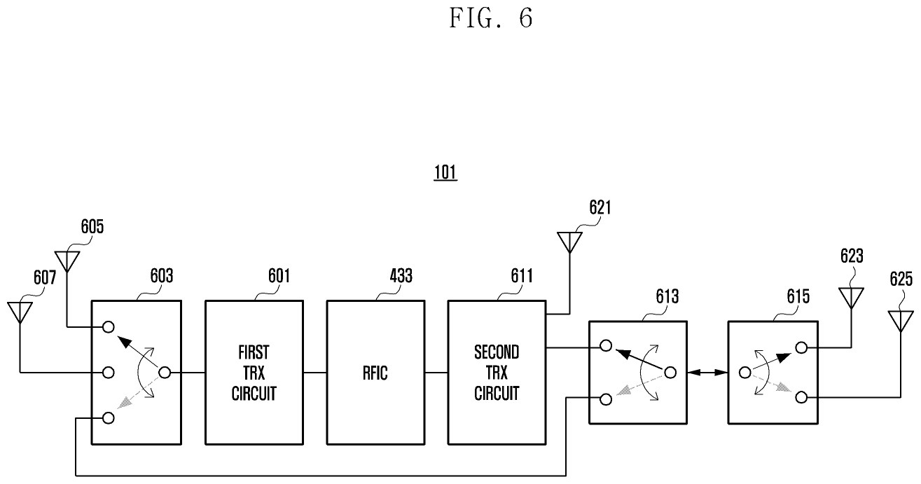

The operation mode of antenna switching can be distinguished according to the number of antennas transmitting a reference signal during a specific time (or, specific slot). Assuming that the electronic device 101 transmits a reference signal using four antennas, the operation mode of antenna switching may include operation mode 2T4R (referred to as first operation mode) in which four reference signals for two TRx circuits (e.g., first TRx circuit 601 and second TRx circuit 611 in FIG. 6) are transmitted through two antennas during a specific time (or, specific slot), and operation mode 1T4R (referred to as second operation mode) in which four reference signals for one TRx circuit (e.g., first TRx circuit 601 in FIG. 6) are transmitted through four antennas during a specific time (or, specific slot).

According to one example, when the electronic device 101 operates in the first operation mode, at a specific time, the first TRx circuit 601 may transmit a reference signal through the first antenna 605, and the second TRx circuit 611 may transmit a reference signal through the third antenna 623; at another specific time, the first TRx circuit 601 may transmit a reference signal through the second antenna 607, and the second TRx circuit 611 may transmit a reference signal through the fourth antenna 625.

According to one example, when the electronic device 101 operates in the second operation mode, at a specific time, the first TRx circuit 601 may transmit a reference signal through the first antenna 605; at another specific time, the first TRx circuit 601 may transmit a reference signal through the second antenna 607; at another specific time, the first TRx circuit 601 may transmit a reference signal through the third antenna 623; at another specific time, the first TRx circuit 601 may transmit a reference signal through the fourth antenna 625.

A change in operation mode of antenna switching may cause a change in the number of times the state of the switch (e.g., switch 437 in FIG. 4B) connected to the plural antennas 530 is changed, and the communication processor 510 may perform a series of operations to change the operation mode of antenna switching so as to reduce the number of times the state of the switch 437 is changed.

The communication processor 510 may transmit a UE capability message to change the operation mode of antenna switching to the cellular network 400. According to one example, the communication processor 510 may transmit a UE capability message, which includes information indicating an operation mode of antenna switching that reduces the number of changes in the state of the switch 437 electrically connected to the plural antennas 530, to the cellular network 400. The information indicating an operation mode of antenna switching may be included in a SupportedSRS-TxPortSwitch field of the UE capability message.

The first node 410 (or, cellular network 400) having received the UE capability message including information indicating an operation mode of antenna switching may determine the operation mode of antenna switching to be performed by the electronic device 101 in consideration of the information indicating an operation mode of antenna switching, and transmit information indicating the determined operation mode to the electronic device 101. The information indicating the determined operation mode may be included in an RRC reconfiguration message; the communication processor 510 having received the information indicating the determined operation mode may transmit a reference signal through the first frequency band according to the determined operation mode.

According to one example, changing the operation related to transmission of a reference signal of the first frequency band may include setting (or changing) the transmission periodicity of the reference signal to be relatively long.

The communication processor 510 may determine the transmission periodicity of a reference signal based on the quality of the second frequency band. According to one example, the communication processor 510 may identify the quality of the second frequency band based on various signals (e.g., signals received during the attachment process with the cellular network 400) from the second node 420 through the second frequency band. According to one example, the communication processor 510 may identify the quality of the second frequency band based on the characteristics of resources (e.g., MCS level or throughput) allocated to the signal transmission or reception through the second frequency band. The higher the MCS level or throughput, the higher the quality of the second frequency band may be. According to one example, the communication processor 510 may identify the quality of the second frequency band based on the error rate (e.g., BLER) of the signal received through the second frequency band. The higher the error rate of the signal received through the second frequency band, the lower the quality of the second frequency band may be.

By setting (or changing) the transmission periodicity of a reference signal to be relatively long, the number of reference signals transmitted during a specific time can be reduced.

The communication processor 510 may determine the transmission periodicity of a reference signal according to the error rate of the signal received through the second frequency band. According to one example, the communication processor 510 may identify that the error rate of the signal received through the second frequency band is within a first range (e.g., 0% to 20%), and determine the transmission periodicity of a reference signal to be a first value (e.g., 20 ms). The communication processor 510 may identify that the error rate of the signal received through the second frequency band is within a second range (e.g., 20% to 50%), and determine the transmission periodicity of a reference signal to be a second value (e.g., 40 ms or 80 ms).

The communication processor 510 may transmit, to the cellular network 400, a UE capability message containing information indicating a relatively long transmission periodicity of a reference signal. The information indicating a transmission periodicity of a reference signal may be included in a TxSwitchImpactToRx field being a subfield of the SupportedSRS-TxPortSwitch field of the UE capability message.

The first node 410 (or, cellular network 400) having received the UE capability message including information indicating a transmission periodicity of a reference signal may determine the transmission periodicity of the reference signal to be used by the electronic device 101 with reference to the information indicating a transmission periodicity of a reference signal, and transmit information indicating the determined periodicity to the electronic device 101. The information indicating the determined periodicity may be included in an RRC reconfiguration message; the communication processor 510 having received the information indicating the determined periodicity may transmit a reference signal through the first frequency band according to the determined periodicity.

According to one example, changing the operation related to transmission of a reference signal in the first frequency band may include setting (or changing) the number of transmissions of the reference signal to be relatively large during a specified time (or, size of a specified slot).

Increasing the number of transmissions of a reference signal during a specified time may refer, for example, to increasing the time (or, number of slots) during which no reference signal is transmitted. According to one example, when the electronic device 101 transmits or receives a signal in the first frequency band using a sub-carrier spacing (SCS) with a size of 30 KHz, the number of slots included in one frame may be 20. Assuming that a total of 4 reference signals are transmitted in 20 slots, the number of slots that do not transmit a reference signal (e.g., 18) when two reference signals are transmitted in one slot may be greater than the number of slots that do not transmit a reference signal (e.g., 16) when one reference signal is transmitted in one slot. Hence, the time required to transmit reference signals can be reduced, and the quality of the signal received through another frequency band can be reduced in a relatively small extent due to transmission of a reference signal.

The communication processor 510 may transmit, to the cellular network 400, a UE capability message containing information indicating the number of transmissions of a reference signal per unit time (or, per slot) set (or changed) to be relatively large. The information indicating the number of transmissions of a reference signal per unit time (or, per slot) may be included in a TxSwitchImpactToRx field being a subfield of the SupportedSRS-TxPortSwitch field in a UE capability message.

The first node 410 (or, cellular network 400) having received a UE capability message including the number of transmissions of a reference signal per unit time (or, per slot) may determine the number of transmissions of a reference signal to be used by the electronic device 101 with reference to the number of transmissions of a reference signal per unit time (or, per slot), and transmit information indicating the determined number of transmissions to the electronic device 101. The information indicating the determined number of transmissions may be included in an RRC reconfiguration message; the communication processor 510 having received information indicating the determined number of transmissions may transmit a reference signal through the first frequency band according to the determined number of transmissions.

According to one example, changing the operation related to transmission of a reference signal in the first frequency band may include setting the occasion of transmitting a reference signal through the first frequency band to be different from the occasion of transmitting information indicating the quality of the signal through the second frequency band (or, the occasion to measure the quality of the signal received through the second frequency band).

By setting the time point of transmitting a reference signal through the first frequency band to be different from the occasion of transmitting information indicating the quality of the signal through the second frequency band (or, the occasion to measure the quality of the signal received through the second frequency band), the communication processor 510 may prevent and/or reduce degradation of the quality of the received signal due to transmitting a reference signal through the first frequency band at the time when the quality of the signal in the second frequency band is transmitted (or, at the time when the quality of the signal received through the second frequency band is measured), so that it is possible to avoid situations in which relatively low-performance resources are allocated.

The communication processor 510 may transmit, to the cellular network 400, a UE capability message including information indicating the occasion of transmitting a reference signal through the first frequency band set to be different from the occasion of transmitting information indicating the quality of the signal through the second frequency band (or, the occasion to measure the quality of the signal received through the second frequency band). The information indicating the occasion of transmitting a reference signal through the first frequency band may be included in a TxSwitchImpactToRx field being a subfield of the SupportedSRS-TxPortSwitch field in a UE capability message.

Upon receiving the UE capability message including information indicating the occasion of transmitting a reference signal through the first frequency band set to be different from the time point of transmitting information indicating the quality of the signal through the second frequency band (or, the time point to measure the quality of the signal received through the second frequency band), the first node 410 (or, cellular network 400) may determine the occasion of transmitting a reference signal to be used by the electronic device 101 and transmit information indicating the determined transmission occasion to the electronic device 101. The information indicating the determined transmission time point may be included in an RRC reconfiguration message; the communication processor 510 having received the information indicating the determined transmission occasion may transmit a reference signal through the first frequency band according to the determined number of transmissions.

According to one example, changing the operation related to transmission of a reference signal in the first frequency band may include configuring not to transmit a reference signal through the first frequency band.

When no reference signal is transmitted through the first frequency band, it is possible to prevent and/or reduce deterioration in the quality of the signal received through the second frequency band.

In order not to transmit a reference signal through the first frequency band, the communication processor 510 may transmit a UE capability message indicating that transmission of a reference signal through the first frequency band is not supported to the cellular network 400. Information indicating that transmission of a reference signal through the first frequency band is not supported may be included in a TxSwitchImpactToRx field being a subfield of the SupportedSRS-TxPortSwitch field in a UE capability message.

Upon receiving the UE capability message indicating that transmission of a reference signal through the first frequency band is not supported, the first node 410 (or, cellular network 400) may determine the electronic device 101 not to transmit a reference signal and transmit information indicating non-transmission of a reference signal to the electronic device 101. Information indicating non-transmission of a reference signal may be included in an RRC reconfiguration message, and the communication processor 510 may not transmit a reference signal through the first frequency band. The first node 410 (or, cellular network 400) having failed to receive a reference signal may estimate (or, determine) the state of the channel in the first frequency band based on a previously received reference signal, and allocate resources to be used by the electronic device 101. Even if the first node 410 does not receive a reference signal, it can estimate the state of the channel using a previously received reference signal; the state of the channel estimated using a previously received reference signal may be not significantly different from the state of the channel when assuming that a reference signal is received. The first node 410 (or, cellular network 400) may transmit information (e.g., MCS level) related to resources allocated to the electronic device 101 to the electronic device 101. The communication processor 510 may transmit and/or receive data through the first frequency band using the allocated resources.

The communication processor 510 may use the method described above to reduce (or prevent) degradation of the quality of the signal received through the second frequency band due to transmission of a reference signal through the first frequency band, thereby avoiding (or, preventing) situations in which relatively low-performance resources are allocated in relation to the second frequency band.

According to one example, the communication processor 510 may transmit UE capability information to the cellular network 400 through the first node 410 in a manner described above. With reference to the UE capability information, the first node 410 (or, cellular network 400) may transmit an RRC reconfiguration message including parameters related to transmission of a reference signal through the first frequency band to the electronic device 101.

The communication processor 510 may identify parameters related to transmission of a reference signal through the first frequency band included in an RRC reconfiguration message, and determine whether they are the same as (or, similar to) those parameters configured by the communication processor 510.

If the parameters related to transmission of a reference signal through the first frequency band included in the RRC reconfiguration message are not the same as those parameters configured by the communication processor 510, the communication processor 510 may transmit the UE capability information to the cellular network 400 again.

To transmit UE capability information, the communication processor 510 may perform a series of operations to release the connection (or, RRC connection) with the first node 410 (or, cellular network 400) through the first frequency band.

According to one example, the communication processor 510 may transmit information indicating that the quality of the signal transmitted through the first frequency band is not suitable for performing cellular communication through the first frequency band (e.g., CQI (channel quality indicator) set to 0 or SCG failure signal) to the first node 410. Upon receiving information indicating that the quality of the signal transmitted through the first frequency band is not suitable for performing cellular communication through the first frequency band, the first node 410 may release the connection with the electronic device 101 through the first frequency band.

According to one example, the communication processor 510 may not transmit information (e.g., measurement report) indicating the quality of the signal in the first frequency band to the first node 410 (or, cellular network 400) for a specified time. The first node 410 having failed to receive information indicating the quality of the signal in the first frequency band for more than a specific period of time may release the connection with the electronic device 101 through the first frequency band.

According to one example, the communication processor 510 may not perform a decoding operation on a control signal (e.g., PDSCH) received through the first frequency band. If a decoding operation is not performed on the control signal, the electronic device 101 may be unable to smoothly connect to the first node 410 through the first frequency band, and the first node 410 may release the connection with the electronic device 101 through the first frequency band.

After releasing the connection with the first node 410, the communication processor 510 may perform an attach operation again with the first node 410, and transmit UE capability information during the attach operation with the first node 410. As the communication processor 510 transmits UE capability information including parameters configured by itself, the communication processor 510 may induce the cellular network 400 to transmit an RRC reconfiguration message containing the same parameters as those parameters configured by the communication processor 510.

FIG. 6 is a block diagram illustrating an example configuration of an electronic device outputting a reference signal in a first operation mode or second operation mode according to various embodiments.

With reference to FIG. 6, the electronic device 101 (e.g., electronic device 101 in FIG. 1) may include an RFIC 433 (e.g., RFIC 433 in FIG. 4B), a first TRx circuit 601 (e.g., first RFFE 232, second RFFE 234 in FIG. 2), a second TRx circuit 611 (e.g., first RFFE 232, second RFFE 234 in FIG. 2), a first switch 603 electrically connected to the first TRx circuit 601, a second switch 613 electrically connected to the second TRx circuit 611, a third switch 615 electrically connected to the second switch 613, a fourth antenna 605, a fifth antenna 607, a sixth antenna 621, a seventh antenna 623, and an eighth antenna 625.

As described above with reference to FIG. 5, the electronic device 101 may support antenna switching for transmitting a reference signal of the first frequency band. Antenna switching may refer to changing the antenna to transmit a reference signal.

The operation mode of antenna switching can be distinguished according to the number of antennas transmitting a reference signal during a specific time (or, specific slot). Assuming that the electronic device 101 transmits a reference signal using four antennas (e.g., fourth antenna 605, fifth antenna 607, seventh antenna 623, and eighth antenna 625), the operation mode of antenna switching may include operation mode 2T4R (referred to as first operation mode) in which a reference signal is transmitted through two antennas during a specific time (or, specific slot), and operation mode 1T4R (referred to as second operation mode) in which a reference signal is transmitted through one antenna during a specific time (or, specific slot).

The first operation mode may refer to an operation mode that transmits a reference signal using both the first TRx circuit 601 and the second TRx circuit 611, and the second operation mode may refer to an operation mode that transmits a reference signal using the first TRx circuit 601.

According to one example, when the electronic device 101 operates in the first operation mode, at a specific time, the first TRx circuit 601 may transmit a reference signal through the fourth antenna 605, and the second TRx circuit 611 may transmit a reference signal through the seventh antenna 623; at another specific time, the first TRx circuit 601 may transmit a reference signal through the fifth antenna 607, and the second TRx circuit 611 may transmit a reference signal through the eighth antenna 625.

According to one example, when the electronic device 101 operates in the second operation mode, at a specific time, the first TRx circuit 601 may transmit a reference signal through the fourth antenna 605; at another specific time, the first TRx circuit 601 may transmit a reference signal through the fifth antenna 607; at another specific time, the first TRx circuit 601 may transmit a reference signal through the seventh antenna 623; at another specific time, the first TRx circuit 601 may transmit a reference signal through the eighth antenna 625.

For convenience of description, it is assumed that the antenna for transmitting a reference signal through the first frequency band is the fourth antenna 605, the fifth antenna 607, the seventh antenna 623, or the eighth antenna 625, and it is assumed that the sixth antenna 621 is an antenna that receives a signal through the second frequency band and is affected by transmission of a reference signal through the seventh antenna 623 or the eighth antenna 625.

In the second operation mode, the electronic device 101 may transmit a reference signal through one of the fourth antenna 605, the fifth antenna 607, the seventh antenna 623, and the eighth antenna 625.

According to one example, to transmit a reference signal through the fourth antenna 605, the electronic device 101 may control the first switch 603 to electrically connect the first TRx circuit 601 and the fourth antenna 605. After transmitting a reference signal through the fourth antenna 605, to transmit a reference signal through the fifth antenna 607, the electronic device 101 may control the first switch 603 to electrically connect the first TRx circuit 601 and the fifth antenna 607. After transmitting a reference signal through the fifth antenna 607, to transmit a reference signal through the seventh antenna 623, the electronic device 101 may control the first switch 603 to electrically connect the first TRx circuit 601 and the second switch 613, control the second switch 613 to electrically connect the first switch 603 and the third switch 615 in a state where the second TRx circuit 611 and the third switch 615 are electrically connected, and control the third switch 615 to electrically connect the seventh antenna 623 and the second switch 613. After transmitting a reference signal through the seventh antenna 623, to transmit a reference signal through the eighth antenna 625, the electronic device 101 may control the first switch 603 to electrically connect the first TRx circuit 601 and the second switch 613, control the second switch 613 to electrically connect the first switch 603 and the third switch 615 in a state where the second TRx circuit 611 and the third switch 615 are electrically connected, and control the third switch 615 to electrically connect the eighth antenna 625 and the second switch 613.

Referring to the above operations, in the second operation mode, the sixth antenna 621 may be affected at least four times due to transmission of a reference signal. For example, the sixth antenna 621 may be affected two times by a state change of the second switch 613 and the third switch 615 for transmitting a reference signal through the seventh antenna 623 (one time) and a state change of the second switch 613 and the third switch 615 for transmitting a reference signal through the eighth antenna 625 (one time).

On the other hand, in the first operation mode, the electronic device 101 may transmit a reference signal through two of the fourth antenna 605, the fifth antenna 607, the seventh antenna 623, and the eighth antenna 625.

In the first operation mode, the electronic device 101 may transmit a reference signal through one of the fourth antenna 605 and the fifth antenna 607 and one of the seventh antenna 623 and the eighth antenna 625. In the first operation mode, the electronic device 101 may transmit a reference signal using both the first TRx circuit 601 and the second TRx circuit 611. According to an embodiment, when the electronic device 101 remains in the first operation mode, a change in the state of the second switch 613 may not occur. This is because the state change of the second switch 613 is a state change for electrical connection with the first switch 603, and when a reference signal is transmitted through the second TRx circuit 611, electrical connection between the second switch 613 and the first switch 603 is not required.

According to one example, the electronic device 101 may not separately control the second switch 613 and the third switch 615 to output a reference signal through the seventh antenna 623. After outputting a reference signal through the seventh antenna 623, to output a reference signal through the eighth antenna 625, the electronic device 101 may release the electrical connection between the second switch 613 and the seventh antenna 623 and control the third switch 615 to electrically connect the second switch 613 and the eighth antenna 625.

Referring to the above operations, in the first operation mode, the sixth antenna 621 may be affected at least once due to transmission of a reference signal. For example, the sixth antenna 621 may be affected once by a state change of the second switch 613 for transmission of a reference signal through the eighth antenna 625 (one time).

Accordingly, the first operation mode may be an operation mode that has relatively less influence on the sixth antenna 621 compared to the second operation mode. The electronic device 101 may perform a series of operations to change the operation mode of antenna switching so as to reduce the number of times the state of the switch is changed. The electronic device 101 may transmit a UE capability message to change the operation mode of antenna switching to the cellular network 400. According to one example, the electronic device 101 may transmit, to the cellular network 400, a UE capability message containing information indicating an operation mode (e.g., first operation mode) of antenna switching that reduces the number of changes in the state of the switch electrically connected to the plural antennas 530.

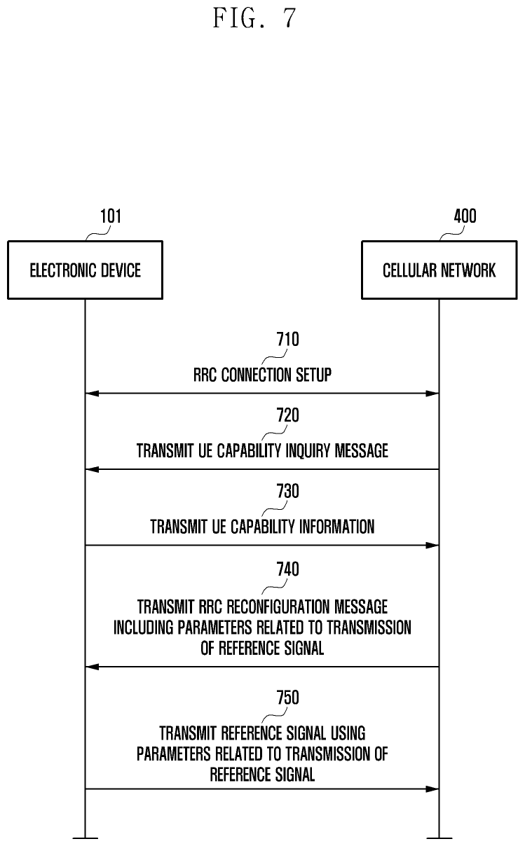

FIG. 7 is a signal flow diagram illustrating an example operation of an electronic device that transmits UE capability information according to various embodiments.

At operation 710, the electronic device (e.g., electronic device 101 in FIG. 5) may establish an RRC connection with the cellular network 400 (e.g., cellular network 400 in FIG. 4A).

The electronic device 101 may transmit an RRC connection request message (e.g., RRC connection request message in E-UTRA, or RRC setup request message in NR) to the cellular network 400 according to various causes (e.g., initial connection with a node is completed, or a paging message is received while the RRC connection is released). The electronic device 101 may receive an RRC connection setup message (e.g., RRC connection setup message in E-UTRA, or RRC setup message in NR) from the cellular network 400 in response to the RRC connection request message. The electronic device 101 may transmit an RRC connection setup complete message (e.g., RRC connection setup complete message in E-UTRA, or RRC setup complete message in NR) to the cellular network 400 in response to the RRC connection setup message.

At operation 720, the cellular network 400 may transmit a UE capability inquiry message to the electronic device 101.

After the RRC connection with the electronic device 101 is established, if UE capability information is required, the cellular network 400 may transmit a UE capability request message to the electronic device 101. UE capability information may refer to information indicating the performance of the electronic device 101 in relation to cellular communication of the electronic device 101.

The cellular network 400 may transmit, to the electronic device 101, a UE capability inquiry message containing information indicating the performance of the electronic device 101 related to cellular communication of the electronic device 101.

The UE capability inquiry message may include information indicating a combination of frequency bands supported by the cellular network 400.

According to one example, the electronic device 101 may receive a signal including information indicating a combination of a first frequency band and a second frequency band, and may be connected to the first node 410 through the first frequency band and to the second node 420 through the second frequency band.

At operation 730, the electronic device 101 may transmit UE capability information to the cellular network 400.

The electronic device 101 may identify whether the combination of frequency bands included in the information indicating a combination of frequency bands is a combination of designated frequency bands.

A combination of designated frequency bands may refer to a combination of a frequency band of a reference signal and a frequency band of a reception signal that receives interference from transmission of the reference signal. According to one example, the combination of designated frequency bands may include a combination of a first frequency band to transmit a reference signal and a second frequency band that receives interference from transmission of the reference signal.

Upon identifying that the combination of frequency bands included in the information indicating a combination of frequency bands is a combination of designated frequency bands, the electronic device 101 may transmit UE capability information including parameters related to transmission of a reference signal of the first frequency band among the combination of frequency bands. Alternatively, upon identifying that the combination of frequency bands included in the information indicating a combination of frequency bands is a combination of designated frequency bands, the electronic device 101 may transmit, to the cellular network 400, UE capability information including information for changing the operation related to transmission of a reference signal of the first frequency band among the combination of frequency bands.

Changing the operation related to transmission of a reference signal of the first frequency band may refer to various operations for preventing and/or reducing the quality of the signal of the second frequency band from being deteriorated due to transmission of a reference signal in the first frequency band.

According to one example, changing the operation related to transmission of a reference signal of the first frequency band may include changing the operation mode of antenna switching for transmission of the reference signal.

Antenna switching may refer to changing the antenna to transmit a reference signal. According to one example, the electronic device 101 supporting antenna switching may transmit a reference signal to the cellular network 400 through the second antenna 433 at a specific time, and may transmit a reference signal to the cellular network 400 through the third antenna 435 at another specific time.

The operation mode of antenna switching can be distinguished according to the number of antennas transmitting a reference signal during a specific time (or, specific slot). Assuming that the electronic device 101 transmits a reference signal using four antennas, the operation mode of antenna switching may include operation mode 2T4R (referred to as first operation mode) in which four reference signals for two TRx circuits (e.g., first TRx circuit 601 and second TRx circuit 611 in FIG. 6) are transmitted through two antennas during a specific time (or, specific slot), and operation mode 1T4R (referred to as second operation mode) in which four reference signals for one TRx circuit (e.g., first TRx circuit 601 in FIG. 6) are transmitted through four antennas during a specific time (or, specific slot).

According to one example, when the electronic device 101 operates in the first operation mode, at a specific time, the first TRx circuit 601 may transmit a reference signal through the first antenna 431, and the second TRx circuit 611 may transmit a reference signal through the third antenna 433; at another specific time, the first TRx circuit 601 may transmit a reference signal through the second antenna 432, and the second TRx circuit 611 may transmit a reference signal through the fourth antenna 434.

According to one example, when the electronic device 101 operates in the second operation mode, at a specific time, the first TRx circuit 601 may transmit a reference signal through the first antenna 431; at another specific time, the first TRx circuit 601 may transmit a reference signal through the second antenna 432; at another specific time, the first TRx circuit 601 may transmit a reference signal through the third antenna 433; at another specific time, the first TRx circuit 601 may transmit a reference signal through the fourth antenna 434.

A change in operation mode of antenna switching may cause a change in the number of times the state of the switch (e.g., switch 437 in FIG. 4B) connected to the plural antennas 530 is changed, and the electronic device 101 may perform a series of operations to change the operation mode of antenna switching so as to reduce the number of times the state of the switch 437 is changed.

The electronic device 101 may transmit a UE capability message to change the operation mode of antenna switching to the cellular network 400. According to one example, the electronic device 101 may transmit a UE capability message, which includes information indicating an operation mode of antenna switching that reduces the number of changes in the state of the switch 437 electrically connected to the plural antennas 530, to the cellular network 400. The information indicating an operation mode of antenna switching may be included in a SupportedSRS-TxPortSwitch field of the UE capability message.

The first node 410 (or, cellular network 400) having received the UE capability message including information indicating an operation mode of antenna switching may determine the operation mode of antenna switching to be performed by the electronic device 101 in consideration of the information indicating an operation mode of antenna switching, and transmit information indicating the determined operation mode to the electronic device 101. The information indicating the determined operation mode may be included in an RRC reconfiguration message; the electronic device 101 having received the information indicating the determined operation mode may transmit a reference signal through the first frequency band according to the determined operation mode.

According to one example, changing the operation related to transmission of a reference signal of the first frequency band may include setting (or changing) the transmission periodicity of the reference signal to be relatively long.

The electronic device 101 may determine the transmission periodicity of a reference signal based on the quality of the second frequency band. According to one example, the electronic device 101 may identify the quality of the second frequency band based on various signals (e.g., signals received during the attachment process with the cellular network 400) from the second node 420 through the second frequency band. According to one example, the electronic device 101 may identify the quality of the second frequency band based on the characteristics of resources (e.g., MCS level or throughput) allocated to the signal transmission or reception through the second frequency band. The higher the MCS level or throughput, the higher the quality of the second frequency band may be.

By setting (or changing) the transmission periodicity of a reference signal to be relatively long, the number of reference signals transmitted during a specific time can be reduced. The electronic device 101 may transmit, to the cellular network 400, a UE capability message containing information indicating a relatively long transmission periodicity of a reference signal. The information indicating a transmission periodicity of a reference signal may be included in a TxSwitchImpactToRx field being a subfield of the SupportedSRS-TxPortSwitch field of the UE capability message.

The first node 410 (or, cellular network 400) having received the UE capability message including information indicating a transmission periodicity of a reference signal may determine the transmission periodicity of the reference signal to be used by the electronic device 101 with reference to the information indicating a transmission periodicity of a reference signal, and transmit information indicating the determined periodicity to the electronic device 101. The information indicating the determined periodicity may be included in an RRC reconfiguration message; the electronic device 101 having received the information indicating the determined periodicity may transmit a reference signal through the first frequency band according to the determined periodicity.

According to one example, changing the operation related to transmission of a reference signal in the first frequency band may include setting (or changing) the number of transmissions of the reference signal to be relatively large during a specified time (or, size of a specified slot).

Increasing the number of transmissions of a reference signal during a specified time may refer, for example, to increasing the time (or, number of slots) during which no reference signal is transmitted. According to one example, the number of slots that do not transmit a reference signal (e.g., 18) when two reference signals are transmitted in one slot may be greater than the number of slots that do not transmit a reference signal (e.g., 16) when one reference signal is transmitted in one slot. Hence, the time required to transmit reference signals can be reduced, and the quality of the signal received through another frequency band can be reduced in a relatively small extent due to transmission of a reference signal.

The electronic device 101 may transmit, to the cellular network 400, a UE capability message containing information indicating the number of transmissions of a reference signal per unit time (or, per slot) set (or changed) to be relatively large. The information indicating the number of transmissions of a reference signal per unit time (or, per slot) may be included in a TxSwitchImpactToRx field being a subfield of the SupportedSRS-TxPortSwitch field in the UE capability message.

The first node 410 (or, cellular network 400) having received a UE capability message including the number of transmissions of a reference signal per unit time (or, per slot) may determine the number of transmissions of a reference signal to be used by the electronic device 101 with reference to the number of transmissions of a reference signal per unit time (or, per slot), and transmit information indicating the determined number of transmissions to the electronic device 101. The information indicating the determined number of transmissions may be included in an RRC reconfiguration message; the electronic device 101 having received information indicating the determined number of transmissions may transmit a reference signal through the first frequency band according to the determined number of transmissions.

According to one example, changing the operation related to transmission of a reference signal in the first frequency band may include setting the occasion of transmitting a reference signal through the first frequency band to be different from the occasion of transmitting information indicating the quality of the signal through the second frequency band (or, the occasion to measure the quality of the signal received through the second frequency band).

By setting the time point of transmitting a reference signal through the first frequency band to be different from the occasion of transmitting information indicating the quality of the signal through the second frequency band (or, the occasion to measure the quality of the signal received through the second frequency band), the electronic device 101 may prevent and/or reduce degradation of the quality of the received signal due to transmitting a reference signal through the first frequency band at the time when the quality of the signal in the second frequency band is transmitted (or, at the time when the quality of the signal received through the second frequency band is measured), so that it is possible to avoid situations in which relatively low-performance resources are allocated.

The electronic device 101 may transmit, to the cellular network 400, a UE capability message including information indicating the occasion of transmitting a reference signal through the first frequency band set to be different from the occasion of transmitting information indicating the quality of the signal through the second frequency band (or, the occasion to measure the quality of the signal received through the second frequency band). The information indicating the occasion of transmitting a reference signal through the first frequency band may be included in a TxSwitchImpactToRx field being a subfield of the SupportedSRS-TxPortSwitch field in a UE capability message.

Upon receiving the UE capability message including information indicating the occasion of transmitting a reference signal through the first frequency band set to be different from the occasion of transmitting information indicating the quality of the signal through the second frequency band (or, the occasion to measure the quality of the signal received through the second frequency band), the first node 410 (or, cellular network 400) may determine the occasion of transmitting a reference signal to be used by the electronic device 101 and transmit information indicating the determined transmission occasion to the electronic device 101. The information indicating the determined transmission time point may be included in an RRC reconfiguration message; the electronic device 101 having received the information indicating the determined transmission occasion may transmit a reference signal through the first frequency band according to the determined number of transmissions.

According to one example, changing the operation related to transmission of a reference signal in the first frequency band may include configuring not to transmit a reference signal through the first frequency band.

When no reference signal is transmitted through the first frequency band, it is possible to prevent and/or reduce deterioration in the quality of the signal received through the second frequency band.

In order not to transmit a reference signal through the first frequency band, the electronic device 101 may transmit a UE capability message indicating that transmission of a reference signal through the first frequency band is not supported to the cellular network 400. Information indicating that transmission of a reference signal through the first frequency band is not supported may be included in a TxSwitchImpactToRx field being a subfield of the SupportedSRS-TxPortSwitch field in a UE capability message.

Upon receiving the UE capability message indicating that transmission of a reference signal through the first frequency band is not supported, the first node 410 (or, cellular network 400) may determine the electronic device 101 not to transmit a reference signal and transmit information indicating non-transmission of a reference signal to the electronic device 101. Information indicating non-transmission of a reference signal may be included in an RRC reconfiguration message, and the electronic device 101 may not transmit a reference signal through the first frequency band.

The electronic device 101 may use the method described above to reduce (or prevent) degradation of the quality of the signal received through the second frequency band due to transmission of a reference signal through the first frequency band, thereby avoiding (or, preventing) situations in which relatively low-performance resources are allocated in relation to the second frequency band.

At operation 740, the cellular network 400 may transmit an RRC reconfiguration message including parameters related to transmission of a reference signal to the electronic device 101.

The cellular network 400 may determine parameters related to transmission of a reference signal to be used by the electronic device 101 in consideration of the parameters related to transmission of a reference signal configured by the electronic device 101 included in the UE capability information.

By transmitting UE capability information including parameters configured by the electronic device 101, the electronic device 101 may induce the cellular network 400 to transmit an RRC reconfiguration message containing the same parameters as those parameters configured by the electronic device 101.

According to one example, the cellular network 400 may identify the quality of a signal transmitted by the electronic device 101 and determine parameters related to transmission of a reference signal based on the quality of the signal.

The cellular network 400 may transmit, to the electronic device 101, parameters related to transmission of a reference signal including information instructing transmission of a reference signal through the first frequency band on a first periodicity. The electronic device 101 may transmit a reference signal through the first frequency band on the first periodicity, and may measure the quality of a signal received through the second frequency band and transmit first information indicating the quality of the received signal to the cellular network 400.

The cellular network 400 may transmit, to the electronic device 101, parameters related to transmission of a reference signal including information instructing transmission of a reference signal through the first frequency band on a second periodicity different from the first periodicity. The electronic device 101 may transmit a reference signal through the first frequency band on the second periodicity, and may measure the quality of a signal received through the second frequency band and transmit second information indicating the quality of the received signal to the cellular network 400.

The cellular network 400 may compare the first information and the second information to determine (or identify) the transmission periodicity of a reference signal in correspondence to the quality having a higher value. The cellular network 400 may transmit parameters related to transmission of a reference signal including the determined transmission periodicity to the electronic device 101, so that the communication quality of the electronic device 101 can be improved.

At operation 750, the electronic device 101 may transmit a reference signal to the cellular network 400 using the parameters related to transmission of a reference signal.

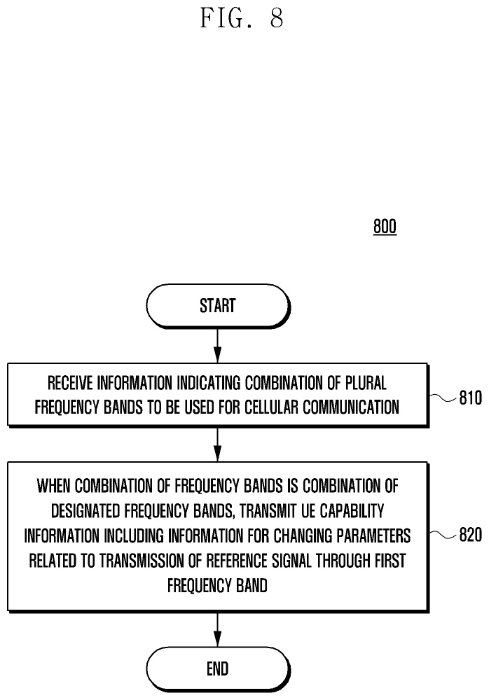

FIG. 8 is a flowchart 800 illustrating an example method of operating the electronic device according to various embodiments.

At operation 810, the electronic device (e.g., electronic device 101 in FIG. 5) may receive information indicating a combination of plural frequency bands to be used for cellular communication.

According to one example, while the electronic device 101 is being connected to the cellular network 400 through the first node 410 and the second node 420, it may receive information indicating a combination of frequency bands to be used for cellular communication from the cellular network 400. Information indicating a combination of frequency bands to be used for cellular communication may be included in an RRC reconfiguration message or UE capability inquiry message received by the electronic device 101 in the process of being attached to the cellular network 400.

According to one example, the electronic device 101 may receive various signals (e.g., UE capability inquiry message or RRC reconfiguration message) in the process of attaching to the cellular network 400. The electronic device 101 may complete the connection procedure with the first node 410 and/or the second node 420 using the information indicating a combination of frequency bands. According to one example, the electronic device 101 may receive a signal including information indicating a combination of a first frequency band and a second frequency band, and may be connected to the first node 410 through the first frequency band and may be connected to the second node 420 through the second frequency band.

At operation 820, when the combination of frequency bands is a combination of designated frequency bands, the electronic device 101 may transmit, to the cellular network 400, UE capability information including information for changing the parameters related to transmission of a reference signal through the first frequency band.

The electronic device 101 may identify whether the combination of frequency bands included in the information indicating a combination of frequency bands is a combination of designated frequency bands.

A combination of designated frequency bands may refer to a combination of a frequency band of a reference signal and a frequency band of a reception signal that receives interference from transmission of the reference signal. According to one example, the combination of designated frequency bands may include a combination of a first frequency band to transmit a reference signal and a second frequency band that receives interference from transmission of the reference signal.

Upon identifying that the combination of frequency bands included in the information indicating a combination of frequency bands is a combination of designated frequency bands, the electronic device 101 may transmit UE capability information including parameters related to transmission of a reference signal of the first frequency band among the combination of frequency bands. Alternatively, upon identifying that the combination of frequency bands included in the information indicating a combination of frequency bands is a combination of designated frequency bands, the electronic device 101 may transmit, to the cellular network 400, UE capability information including information for changing the operation related to transmission of a reference signal of the first frequency band among the combination of frequency bands.

Changing the operation related to transmission of a reference signal of the first frequency band may refer to various operations for preventing and/or reducing the quality of the signal of the second frequency band from being deteriorated due to transmission of a reference signal in the first frequency band.

According to one example, changing the operation related to transmission of a reference signal of the first frequency band may include changing the operation mode of antenna switching for transmission of the reference signal.

Antenna switching may refer to changing the antenna to transmit a reference signal. According to one example, the electronic device 101 supporting antenna switching may transmit a reference signal to the cellular network 400 through the second antenna 433 at a specific time, and may transmit a reference signal to the cellular network 400 through the third antenna 435 at another specific time.

The operation mode of antenna switching can be distinguished according to the number of antennas transmitting a reference signal during a specific time (or, specific slot). Assuming that the electronic device 101 transmits a reference signal using four antennas, the operation mode of antenna switching may include operation mode 2T4R (referred to as first operation mode) in which four reference signals for two TRx circuits (e.g., first TRx circuit 601 and second TRx circuit 611 in FIG. 6) are transmitted through two antennas during a specific time (or, specific slot), and operation mode 1T4R (referred to as second operation mode) in which four reference signals for one TRx circuit (e.g., first TRx circuit 601 in FIG. 6) are transmitted through four antennas during a specific time (or, specific slot).

According to one example, when the electronic device 101 operates in the first operation mode, at a specific time, the first TRx circuit 601 may transmit a reference signal through the first antenna 431, and the second TRx circuit 611 may transmit a reference signal through the third antenna 433; at another specific time, the first TRx circuit 601 may transmit a reference signal through the second antenna 432, and the second TRx circuit 611 may transmit a reference signal through the fourth antenna 434.

According to one example, when the electronic device 101 operates in the second operation mode, at a specific time, the first TRx circuit 601 may transmit a reference signal through the first antenna 431; at another specific time, the first TRx circuit 601 may transmit a reference signal through the second antenna 432; at another specific time, the first TRx circuit 601 may transmit a reference signal through the third antenna 433; at another specific time, the first TRx circuit 601 may transmit a reference signal through the fourth antenna 434.

A change in operation mode of antenna switching may cause a change in the number of times the state of the switch (e.g., switch 437 in FIG. 4B) connected to the plural antennas 530 is changed, and the electronic device 101 may perform a series of operations to change the operation mode of antenna switching so as to reduce the number of times the state of the switch 437 is changed.

The electronic device 101 may transmit a UE capability message to change the operation mode of antenna switching to the cellular network 400. According to one example, the electronic device 101 may transmit a UE capability message, which includes information indicating an operation mode of antenna switching that reduces the number of changes in the state of the switch 437 electrically connected to the plural antennas 530, to the cellular network 400. The information indicating an operation mode of antenna switching may be included in a SupportedSRS-TxPortSwitch field of the UE capability message.

The first node 410 (or, cellular network 400) having received the UE capability message including information indicating an operation mode of antenna switching may determine the operation mode of antenna switching to be performed by the electronic device 101 in consideration of the information indicating an operation mode of antenna switching, and transmit information indicating the determined operation mode to the electronic device 101. The information indicating the determined operation mode may be included in an RRC reconfiguration message; the electronic device 101 having received the information indicating the determined operation mode may transmit a reference signal through the first frequency band according to the determined operation mode.

According to one example, changing the operation related to transmission of a reference signal of the first frequency band may include setting (or changing) the transmission periodicity of the reference signal to be relatively long.

The electronic device 101 may determine the transmission periodicity of a reference signal based on the quality of the second frequency band. According to one example, the electronic device 101 may identify the quality of the second frequency band based on various signals (e.g., signals received during the attachment process with the cellular network 400) from the second node 420 through the second frequency band. According to one example, the electronic device 101 may identify the quality of the second frequency band based on the characteristics of resources (e.g., MCS level or throughput) allocated to the signal transmission or reception through the second frequency band. The higher the MCS level or throughput, the higher the quality of the second frequency band may be.

By setting (or changing) the transmission periodicity of a reference signal to be relatively long, the number of reference signals transmitted during a specific time can be reduced. The electronic device 101 may transmit, to the cellular network 400, a UE capability message containing information indicating a relatively long transmission periodicity of a reference signal. The information indicating a transmission periodicity of a reference signal may be included in a TxSwitchImpactToRx field being a subfield of the SupportedSRS-TxPortSwitch field in the UE capability message.

The first node 410 (or, cellular network 400) having received the UE capability message including information indicating a transmission periodicity of a reference signal may determine the transmission periodicity of the reference signal to be used by the electronic device 101 with reference to the information indicating a transmission periodicity of a reference signal, and transmit information indicating the determined periodicity to the electronic device 101. The information indicating the determined periodicity may be included in an RRC reconfiguration message; the electronic device 101 having received the information indicating the determined periodicity may transmit a reference signal through the first frequency band according to the determined periodicity.

According to one example, changing the operation related to transmission of a reference signal in the first frequency band may include setting (or changing) the number of transmissions of the reference signal to be relatively large during a specified time (or, size of a specified slot).

Increasing the number of transmissions of a reference signal during a specified time may refer, for example, to increasing the time (or, number of slots) during which no reference signal is transmitted. According to one example, the number of slots that do not transmit a reference signal (e.g., 18) when two reference signals are transmitted in one slot may be greater than the number of slots that do not transmit a reference signal (e.g., 16) when one reference signal is transmitted in one slot. Hence, the time required to transmit reference signals can be reduced, and the quality of the signal received through another frequency band can be reduced in a relatively small extent due to transmission of a reference signal.

The electronic device 101 may transmit, to the cellular network 400, a UE capability message containing information indicating the number of transmissions of a reference signal per unit time (or, per slot) set (or changed) to be relatively large. The information indicating the number of transmissions of a reference signal per unit time (or, per slot) may be included in a TxSwitchImpactToRx field being a subfield of the SupportedSRS-TxPortSwitch field in the UE capability message.

The first node 410 (or, cellular network 400) having received a UE capability message including the number of transmissions of a reference signal per unit time (or, per slot) may determine the number of transmissions of a reference signal to be used by the electronic device 101 with reference to the number of transmissions of a reference signal per unit time (or, per slot), and transmit information indicating the determined number of transmissions to the electronic device 101. The information indicating the determined number of transmissions may be included in an RRC reconfiguration message; the electronic device 101 having received information indicating the determined number of transmissions may transmit a reference signal through the first frequency band according to the determined number of transmissions.

According to one example, changing the operation related to transmission of a reference signal in the first frequency band may include setting the time point of transmitting a reference signal through the first frequency band to be different from the time point of transmitting information indicating the quality of the signal through the second frequency band (or, the time point to measure the quality of the signal received through the second frequency band).

By setting the time point of transmitting a reference signal through the first frequency band to be different from the time point of transmitting information indicating the quality of the signal through the second frequency band (or, the time point to measure the quality of the signal received through the second frequency band), the electronic device 101 may prevent and/or reduce degradation of the quality of the received signal due to transmitting a reference signal through the first frequency band at the time when the quality of the signal in the second frequency band is transmitted (or, at the time when the quality of the signal received through the second frequency band is measured), so that it is possible to avoid situations in which relatively low-performance resources are allocated.

The electronic device 101 may transmit, to the cellular network 400, a UE capability message including information indicating the occasion of transmitting a reference signal through the first frequency band set to be different from the time point of transmitting information indicating the quality of the signal through the second frequency band (or, the occasion to measure the quality of the signal received through the second frequency band). The information indicating the occasion of transmitting a reference signal through the first frequency band may be included in a TxSwitchImpactToRx field being a subfield of the SupportedSRS-TxPortSwitch field in a UE capability message.

Upon receiving the UE capability message including information indicating the occasion of transmitting a reference signal through the first frequency band set to be different from the occasion of transmitting information indicating the quality of the signal through the second frequency band (or, the time point to measure the quality of the signal received through the second frequency band), the first node 410 (or, cellular network 400) may determine the occasion of transmitting a reference signal to be used by the electronic device 101 and transmit information indicating the determined transmission occasion to the electronic device 101. The information indicating the determined transmission occasion may be included in an RRC reconfiguration message; the electronic device 101 having received the information indicating the determined transmission occasion may transmit a reference signal through the first frequency band according to the determined number of transmissions.

According to one example, changing the operation related to transmission of a reference signal in the first frequency band may include configuring not to transmit a reference signal through the first frequency band.

When no reference signal is transmitted through the first frequency band, it is possible to prevent and/or reduce deterioration in the quality of the signal received through the second frequency band.

In order not to transmit a reference signal through the first frequency band, the electronic device 101 may transmit a UE capability message indicating that transmission of a reference signal through the first frequency band is not supported to the cellular network 400. Information indicating that transmission of a reference signal through the first frequency band is not supported may be included in a TxSwitchImpactToRx field being a subfield of the SupportedSRS-TxPortSwitch field in a UE capability message.

Upon receiving the UE capability message indicating that transmission of a reference signal through the first frequency band is not supported, the first node 410 (or, cellular network 400) may determine the electronic device 101 not to transmit a reference signal and transmit information indicating non-transmission of a reference signal to the electronic device 101. Information indicating non-transmission of a reference signal may be included in an RRC reconfiguration message, and the electronic device 101 may not transmit a reference signal through the first frequency band.

The electronic device 101 may use the method described above to reduce (or prevent) degradation of the quality of the signal received through the second frequency band due to transmission of a reference signal through the first frequency band, thereby avoiding (or, preventing) situations in which relatively low-performance resources are allocated in relation to the second frequency band.

According to one example, the electronic device 101 may transmit UE capability information to the cellular network 400 through the first node 410 in a manner described above.

The first node 410 (or, cellular network 400) may refer to the UE capability information to transmit an RRC reconfiguration message including parameters related to transmission of a reference signal through the first frequency band to the electronic device 101.

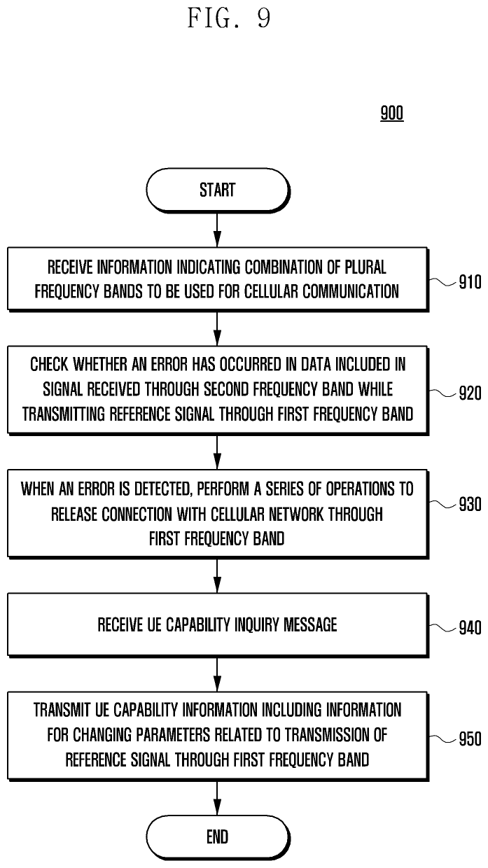

FIG. 9 is a flowchart 900 illustrating an example method of operating the electronic device according to various embodiments.

At operation 910, the electronic device (e.g., electronic device 101 in FIG. 5) may receive information indicating a combination of plural frequency bands to be used for cellular communication.

After the connection procedure with the cellular network (e.g., cellular network 400 in FIG. 4) is completed, the electronic device 101 may receive an RRC reconfiguration message from the cellular network 440.

The RRC reconfiguration message may include information indicating a combination of plural frequency bands to be used by the electronic device 101 for cellular communication, and parameters related to transmission of a reference signal.

Parameters related to a reference signal may refer to various parameters including transmission time point of a reference signal (e.g., information on the slot in which the reference signal can be transmitted), transmission periodicity of a reference signal, and/or operation mode associated with transmission of a reference signal (e.g., first operation mode, or second operation mode).

The electronic device 101 may receive a signal including parameters related to a reference signal, and transmit a reference signal to the first node 410 using the parameters related to a reference signal. Upon receiving a reference signal, the first node 410 may use the information included in the reference signal to allocate resources (e.g., MCS level) required by the electronic device 101 to transmit a signal through a series of operations (e.g., channel estimation). The electronic device 101 may transmit a signal to the first node 410 through resources allocated by the first node 410 (or, cellular network 400).

At operation 920, the electronic device 101 may identify (e.g., check) whether an error has occurred in data included in the signal received through the second frequency band while transmitting a reference signal through the first frequency band.

The electronic device 101 may perform a test on data included in a signal received through the second frequency band. Test on data may refer to checking whether an error exists in data included in a received signal. The electronic device 101 may perform a test on data through various schemes. For example, the electronic device 101 may perform a check on data using a cyclic redundancy check (CRC) scheme.

At operation 930, when an error is detected in data included in the signal received through the second frequency band, the electronic device 101 may perform a series of operations to release a connection with the cellular network 400 through the first frequency band.

When the connection state with the cellular network 400 through the first frequency band is RRC connected state, it may be difficult for the electronic device 101 to transmit UE capability information. Hence, to transmit UE capability information, the electronic device 101 may perform a series of operations to release the connection (or, RRC connection) through the first frequency band with the first node 410 (or, cellular network 400).

According to one example, the electronic device 101 may transmit information indicating that the quality of the signal transmitted through the first frequency band is not suitable for performing cellular communication through the first frequency band (e.g., CQI (channel quality indicator) set to 0 or SCG failure signal) to the first node 410. Upon receiving information indicating that the quality of the signal transmitted through the first frequency band is not suitable for performing cellular communication through the first frequency band, the first node 410 may release the connection with the electronic device 101 through the first frequency band.

According to one example, the electronic device 101 may not transmit information (e.g., measurement report) indicating the quality of the signal in the first frequency band to the first node 410 (or, cellular network 400) for a specified time. The first node 410 having failed to receive information indicating the quality of the signal in the first frequency band for more than a specific period of time may release the connection with the electronic device 101 through the first frequency band.

According to one example, the electronic device 101 may not perform a decoding operation on a control signal (e.g., PDSCH) received through the first frequency band. If a decoding operation is not performed on the control signal, the electronic device 101 may be unable to smoothly connect to the first node 410 through the first frequency band, and the first node 410 may release the connection with the electronic device 101 through the first frequency band.

At operation 940, the electronic device 101 may receive a UE capability inquiry message from the cellular network 400.

At operation 950, the electronic device 101 may transmit UE capability information including information for changing parameters related to transmission of a reference signal through the first frequency band.

The electronic device 101 may transmit UE capability information including parameters related to transmission of a reference signal in the first frequency band.

Changing the operation related to transmission of a reference signal of the first frequency band may refer to various operations for preventing and/or reducing the quality of the signal of the second frequency band from being deteriorated due to transmission of a reference signal in the first frequency band.

According to one example, changing the operation related to transmission of a reference signal of the first frequency band may include changing the operation mode of antenna switching for transmission of the reference signal.

Antenna switching may refer to changing the antenna to transmit a reference signal. According to one example, the electronic device 101 supporting antenna switching may transmit a reference signal to the cellular network 400 through the second antenna 433 at a specific time, and may transmit a reference signal to the cellular network 400 through the third antenna 435 at another specific time.

The operation mode of antenna switching can be distinguished according to the number of antennas transmitting a reference signal during a specific time (or, specific slot). Assuming that the electronic device 101 transmits a reference signal using four antennas, the operation mode of antenna switching may include operation mode 2T4R (referred to as first operation mode) in which four reference signals for two TRx circuits (e.g., first TRx circuit 601 and second TRx circuit 611 in FIG. 6) are transmitted through two antennas during a specific time (or, specific slot), and operation mode 1T4R (referred to as second operation mode) in which four reference signals for one TRx circuit (e.g., first TRx circuit 601 in FIG. 6) are transmitted through four antennas during a specific time (or, specific slot).

According to one example, when the electronic device 101 operates in the first operation mode, at a specific time, the first TRx circuit 601 may transmit a reference signal through the first antenna 431, and the second TRx circuit 611 may transmit a reference signal through the third antenna 433; at another specific time, the first TRx circuit 601 may transmit a reference signal through the second antenna 432, and the second TRx circuit 611 may transmit a reference signal through the fourth antenna 434.

According to one example, when the electronic device 101 operates in the second operation mode, at a specific time, the first TRx circuit 601 may transmit a reference signal through the first antenna 431; at another specific time, the first TRx circuit 601 may transmit a reference signal through the second antenna 432; at another specific time, the first TRx circuit 601 may transmit a reference signal through the third antenna 433; at another specific time, the first TRx circuit 601 may transmit a reference signal through the fourth antenna 434.

A change in operation mode of antenna switching may cause a change in the number of times the state of the switch (e.g., switch 437 in FIG. 4B) connected to the plural antennas 530 is changed, and the electronic device 101 may perform a series of operations to change the operation mode of antenna switching so as to reduce the number of times the state of the switch 437 is changed.

The electronic device 101 may transmit a UE capability message to change the operation mode of antenna switching to the cellular network 400. According to one example, the electronic device 101 may transmit a UE capability message, which includes information indicating an operation mode of antenna switching that reduces the number of changes in the state of the switch 437 electrically connected to the plural antennas 530, to the cellular network 400. The information indicating an operation mode of antenna switching may be included in a SupportedSRS-TxPortSwitch field of the UE capability message.

The first node 410 (or, cellular network 400) having received the UE capability message including information indicating an operation mode of antenna switching may determine the operation mode of antenna switching to be performed by the electronic device 101 in consideration of the information indicating an operation mode of antenna switching, and transmit information indicating the determined operation mode to the electronic device 101. The information indicating the determined operation mode may be included in an RRC reconfiguration message; the electronic device 101 having received the information indicating the determined operation mode may transmit a reference signal through the first frequency band according to the determined operation mode.

According to one example, changing the operation related to transmission of a reference signal of the first frequency band may include setting (or changing) the transmission periodicity of the reference signal to be relatively long.

The electronic device 101 may determine the transmission periodicity of a reference signal based on the quality of the second frequency band. According to one example, the electronic device 101 may identify the quality of the second frequency band based on various signals (e.g., signals received during the attachment process with the cellular network 400) from the second node 420 through the second frequency band. According to one example, the electronic device 101 may identify the quality of the second frequency band based on the characteristics of resources (e.g., MCS level or throughput) allocated to the signal transmission or reception through the second frequency band. The higher the MCS level or throughput, the higher the quality of the second frequency band may be.

By setting (or changing) the transmission periodicity of a reference signal to be relatively long, the number of reference signals transmitted during a specific time can be reduced. The electronic device 101 may transmit, to the cellular network 400, a UE capability message containing information indicating a relatively long transmission periodicity of a reference signal. The information indicating a transmission periodicity of a reference signal may be included in a TxSwitchImpactToRx field being a subfield of the SupportedSRS-TxPortSwitch field of the UE capability message.

The first node 410 (or, cellular network 400) having received the UE capability message including information indicating a transmission periodicity of a reference signal may determine the transmission periodicity of the reference signal to be used by the electronic device 101 with reference to the information indicating a transmission periodicity of a reference signal, and transmit information indicating the determined periodicity to the electronic device 101. The information indicating the determined periodicity may be included in an RRC reconfiguration message; the electronic device 101 having received the information indicating the determined periodicity may transmit a reference signal through the first frequency band according to the determined periodicity.

According to one example, changing the operation related to transmission of a reference signal in the first frequency band may include setting (or changing) the number of transmissions of the reference signal to be relatively large during a specified time (or, size of a specified slot).

Increasing the number of transmissions of a reference signal during a specified time may refer, for example, to increasing the time (or, number of slots) during which no reference signal is transmitted. According to one example, the number of slots that do not transmit a reference signal (e.g., 18) when two reference signals are transmitted in one slot may be greater than the number of slots that do not transmit a reference signal (e.g., 16) when one reference signal is transmitted in one slot. Hence, the time required to transmit reference signals can be reduced, and the quality of the signal received through another frequency band can be reduced in a relatively small extent due to transmission of a reference signal.

The electronic device 101 may transmit, to the cellular network 400, a UE capability message containing information indicating the number of transmissions of a reference signal per unit time (or, per slot) set (or changed) to be relatively large. The information indicating the number of transmissions of a reference signal per unit time (or, per slot) may be included in a TxSwitchImpactToRx field being a subfield of the SupportedSRS-TxPortSwitch field in the UE capability message.

The first node 410 (or, cellular network 400) having received a UE capability message including the number of transmissions of a reference signal per unit time (or, per slot) may determine the number of transmissions of a reference signal to be used by the electronic device 101 with reference to the number of transmissions of a reference signal per unit time (or, per slot), and transmit information indicating the determined number of transmissions to the electronic device 101. The information indicating the determined number of transmissions may be included in an RRC reconfiguration message; the electronic device 101 having received information indicating the determined number of transmissions may transmit a reference signal through the first frequency band according to the determined number of transmissions.

According to one example, changing the operation related to transmission of a reference signal in the first frequency band may include setting the time point of transmitting a reference signal through the first frequency band to be different from the occasion of transmitting information indicating the quality of the signal through the second frequency band (or, the occasion to measure the quality of the signal received through the second frequency band).

By setting the time point of transmitting a reference signal through the first frequency band to be different from the occasion of transmitting information indicating the quality of the signal through the second frequency band (or, the occasion to measure the quality of the signal received through the second frequency band), the electronic device 101 may prevent and/or reduce degradation of the quality of the received signal due to transmitting a reference signal through the first frequency band at the time when the quality of the signal in the second frequency band is transmitted (or, at the time when the quality of the signal received through the second frequency band is measured), so that it is possible to avoid situations in which relatively low-performance resources are allocated.

The electronic device 101 may transmit, to the cellular network 400, a UE capability message including information indicating the occasion of transmitting a reference signal through the first frequency band set to be different from the occasion of transmitting information indicating the quality of the signal through the second frequency band (or, the occasion to measure the quality of the signal received through the second frequency band). The information indicating the time point of transmitting a reference signal through the first frequency band may be included in a TxSwitchImpactToRx field being a subfield of the SupportedSRS-TxPortSwitch field in a UE capability message.

Upon receiving the UE capability message including information indicating the occasion of transmitting a reference signal through the first frequency band set to be different from the time point of transmitting information indicating the quality of the signal through the second frequency band (or, the time point to measure the quality of the signal received through the second frequency band), the first node 410 (or, cellular network 400) may determine the occasion of transmitting a reference signal to be used by the electronic device 101 and transmit information indicating the determined transmission occasion the electronic device 101. The information indicating the determined transmission occasion may be included in an RRC reconfiguration message; the electronic device 101 having received the information indicating the determined transmission occasion may transmit a reference signal through the first frequency band according to the determined number of transmissions.

According to one example, changing the operation related to transmission of a reference signal in the first frequency band may include configuring not to transmit a reference signal through the first frequency band.

When no reference signal is transmitted through the first frequency band, it is possible to prevent and/or reduce deterioration in the quality of the signal received through the second frequency band.

In order not to transmit a reference signal through the first frequency band, the electronic device 101 may transmit a UE capability message indicating that transmission of a reference signal through the first frequency band is not supported to the cellular network 400. Information indicating that transmission of a reference signal through the first frequency band is not supported may be included in a TxSwitchImpactToRx field being a subfield of the SupportedSRS-TxPortSwitch field in a UE capability message.

Upon receiving the UE capability message indicating that transmission of a reference signal through the first frequency band is not supported, the first node 410 (or, cellular network 400) may determine the electronic device 101 not to transmit a reference signal and transmit information indicating non-transmission of a reference signal to the electronic device 101. Information indicating non-transmission of a reference signal may be included in an RRC reconfiguration message, and the electronic device 101 may not transmit a reference signal through the first frequency band. The first node 410 may allocate resources to be used by the electronic device 101 using a previous reference signal received through the first frequency band.

The electronic device 101 may use the method described above to reduce (or prevent) degradation of the quality of the signal received through the second frequency band due to transmission of a reference signal through the first frequency band, thereby avoiding (or, preventing) situations in which relatively low-performance resources are allocated in relation to the second frequency band.

According to one example, the electronic device 101 may transmit UE capability information to the cellular network 400 through the first node 410 in the manner described above. With reference to the UE capability information, the first node 410 (or, cellular network 400) may transmit an RRC reconfiguration message including parameters related to transmission of a reference signal through the first frequency band to the electronic device 101.

An electronic device (e.g., electronic device 101 in FIG. 5) according to an example embodiment may include a plurality of antennas (e.g., plural antennas 530 in FIG. 5). The electronic device may include a communication circuit (e.g., communication circuit 520 in FIG. 5) electrically connected to the plural antennas. The electronic device may include a communication processor, comprising at least one processor, comprising processing circuitry, (e.g., communication processor 510 in FIG. 5) operably connected to the communication circuit. At least one processor, individually and/or collectively, may be configured to control the electronic device to: receive information indicating a combination of frequency bands to be used for cellular communication from a cellular network (e.g., cellular network 400 in FIG. 4A); based on the combination of frequency bands being a combination of designated frequency bands, transmit, to the cellular network, user equipment (UE) capability information including information for changing an operation related to transmission of a reference signal in a first frequency band among the combination of frequency bands; receive, from the cellular network, a signal including parameters related to transmission of a reference signal configured based on the information for changing the operation related to transmission of a reference signal; and transmit a reference signal based on the parameters related to transmission of a reference signal.

In the electronic device according to an example embodiment, the UE capability information may include information for changing a number of antennas transmitting a reference signal during a specified time among the plural antennas.

In the electronic device according to an example embodiment, the UE capability information may include information for adjusting the transmission periodicity of a reference signal.

In the electronic device according to an example embodiment, the UE capability information may include information for changing a number of transmissions of a reference signal during a specified time.

In the electronic device according to an example embodiment, the UE capability information may include information for setting the transmission time of a signal reporting the signal quality of a second frequency band to be different from the transmission time of a reference signal.

In the electronic device according to an example embodiment, the combination of designated frequency bands may include a combination of a frequency band of a reference signal and a frequency band of a reception signal that receives interference from transmission of the reference signal.

In the electronic device according to an example embodiment, based on a signal indicating a change in operation related to transmission of a reference signal not being received after transmission of the UE capability information, at least one processor, individually and/or collectively, may be configured to perform a series of operations to release a connection with the cellular network through the first frequency band to release the connection with the cellular network through the first frequency band; and receive a UE capability inquiry message from the cellular network while connecting again to the cellular network through the first frequency band; and transmit UE capability information including information for changing an operation related to transmission of a reference signal to the cellular network.

In the electronic device according to an example embodiment, at least one processor, individually and/or collectively, may be configured to transmit information indicating that the quality of the signal in the first frequency band is low to release a connection with the cellular network through the first frequency band.

In the electronic device according to an example embodiment, the UE capability information may include information indicating that transmission of a reference signal is not supported. At least one processor, individually and/or collectively, may be configured to receive information related to resources allocated based on a previous reference signal from the cellular; and transmit and/or receive data through the first frequency band using the allocated resources.

A method of operating an electronic device (e.g., electronic device 101 in FIG. 5) according to an example embodiment may include: receiving information indicating a combination of frequency bands to be used for cellular communication from a cellular network (e.g., cellular network 400 in FIG. 4A); based on the combination of frequency bands being a combination of designated frequency bands, transmitting, to the cellular network, user equipment (UE) capability information including information for changing an operation related to transmission of a reference signal in a first frequency band among the combination of frequency; receiving, from the cellular network, a signal including parameters related to transmission of a reference signal configured based on the information for changing the operation related to transmission of a reference signal; and transmitting a reference signal based on the parameters related to transmission of a reference signal.

In the method of operating the electronic device according to an example embodiment, the UE capability information may include information for changing the number of antennas transmitting a reference signal during a specified time among the plural antennas (e.g., plural antennas 530 in FIG. 5) of the electronic device.

In the method of operating the electronic device according to an example embodiment, the UE capability information may include information for adjusting the transmission periodicity of a reference signal.

In the method of operating the electronic device according to an example embodiment, the UE capability information may include information for changing the number of transmissions of a reference signal during a specified time.

In the method of operating the electronic device according to an example embodiment, the UE capability information may include information for setting the transmission time of a signal reporting the signal quality of a second frequency band to be different from the transmission time of a reference signal.

In the method of operating the electronic device according to an example embodiment, the combination of designated frequency bands may include a combination of a frequency band of a reference signal and a frequency band of a reception signal that receives interference from transmission of the reference signal.

A method of operating the electronic device according to an example embodiment may include: performing, based on a signal indicating a change in operation related to transmission of a reference signal not being received after transmission of the UE capability information, a series of operations to release a connection with the cellular network through the first frequency band to release the connection with the cellular network through the first frequency band; receiving a UE capability inquiry message from the cellular network while connecting again to the cellular network through the first frequency band; and transmitting UE capability information including information for changing an operation related to transmission of a reference signal to the cellular network.

In the method of operating the electronic device 101 according to an example embodiment, performing a series of operations to release a connection with the cellular network through the first frequency band may include transmitting information indicating that the quality of the signal in the first frequency band is low.

An electronic device (e.g., electronic device 101 in FIG. 5) according to an example embodiment may include: a plurality of antennas (e.g., plural antennas 530 in FIG. 5). The electronic device may include a communication circuit (e.g., communication circuit 520 in FIG. 5). The electronic device may include a communication processor, comprising at least one processor, comprising processing circuitry, (e.g., communication processor 510 in FIG. 5) operably connected to the communication circuit. At least one processor, individually and/or collectively, may be configured to control the electronic device to: receive information indicating a first frequency band and a second frequency band from a cellular network (e.g., cellular network 400 in FIG. 4A); based on transmitting a reference signal through the first frequency band using at least some of the plural antennas, check whether there is an error in data included in a signal of the second frequency band received through another antenna; based on an error in the data being identified, perform a series of operations to release a connection with the cellular network through the first frequency band; receive a user equipment (UE) capability inquiry message from the cellular network while connecting again to the cellular network 400 through the first frequency band; and transmit UE capability information including information for changing an operation related to transmission of a reference signal to the cellular network.

In the electronic device according to an example embodiment, the UE capability information may include information for changing the number of antennas transmitting a reference signal during a specified time among the plural antennas.

In the electronic device according to an example embodiment, the UE capability information may include information for adjusting the transmission periodicity of a reference signal.

In the electronic device according to an example embodiment, the UE capability information may include information for changing the number of transmissions of a reference signal during a specified time.

In the electronic device according to an example embodiment, the UE capability information may include information for setting the transmission time of a signal reporting the signal quality of the second frequency band to be different from the transmission time of a reference signal.

In the electronic device according to an example embodiment, at least one processor, individually and/or collectively, may be configured to control the electronic device to transmit information indicating that the quality of the signal in the first frequency band is low to release a connection with the cellular network 400 through the first frequency band.

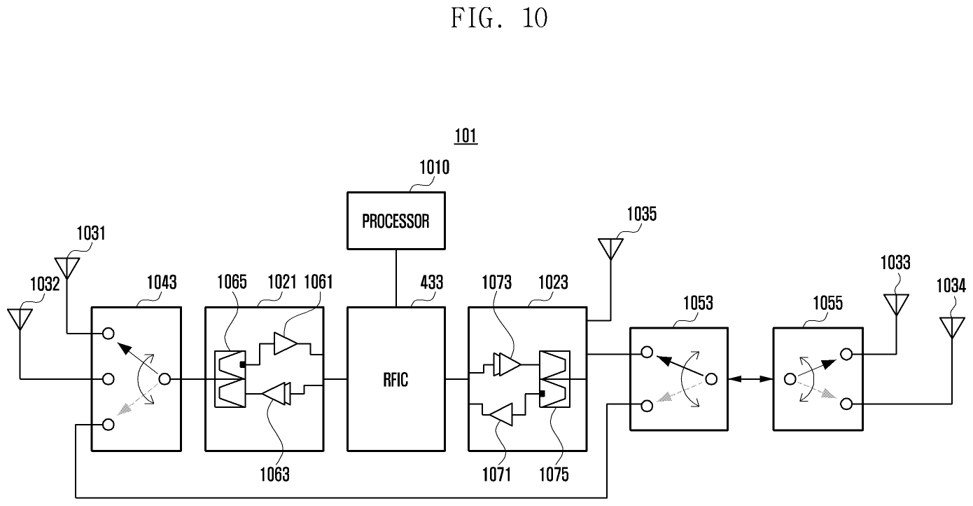

FIG. 10 is a block diagram illustrating an example configuration of an electronic device according to various embodiments.

With reference to FIG. 10, the electronic device (e.g., the electronic device 101 of FIG. 1) may include a processor (e.g., including processing circuitry) 1010 (e.g., the processor 120 of FIG. 1, the first communication processor (e.g., including processing circuitry) 212, and/or the second communication processor (e.g., including processing circuitry) 214 of FIG. 2), an RFIC 433 (e.g., the RFIC 433 of FIG. 4B), a first TRx circuit 1021 (e.g., the wireless communication module 192 of FIG. 1), a second TRx circuit 1023 (e.g., the wireless communication module 192 of FIG. 1), and a plurality of antennas (e.g., a ninth antenna 1031, a tenth antenna 1032, an eleventh antenna 1033, and a twelfth antenna 1034). The processor 1010 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The first TRx circuit 1021 may include one or more RFFEs (e.g., the RFFE 435 of FIG. 4B). The first TRx circuit 1021 may support a standalone mode and/or a non-standalone mode of first cellular communication. The first TRx circuit 1021 may be configured to communicate with the external electronic device 104 through a node (e.g., the first node 410) supporting first cellular communication and/or a node (e.g., the second node 420) supporting second cellular communication in a non-standalone mode of first cellular communication.

The first TRx circuit 1021 may support carrier aggregation in a standalone mode of first cellular communication. In the case of supporting carrier aggregation of first cellular communication, the first TRx circuit 1021 may be configured to communicate with the external electronic device 104 through the first node 410 and the second node 420.

The first TRx circuit 1021 may be electrically connected to at least one of the ninth antenna 1031 or the tenth antenna 1032. According to an example, the first TRx circuit 1021 may include a switch that may electrically connect at least one of the ninth antenna 1031 or the tenth antenna 1032 and at least one component (e.g., multiplexer, amplifier, and low-noise amplifier) included in the first TRx circuit 1021.

The first TRx circuit 1021 may include an amplifier 1063 that amplifies a signal received from the processor 1010, a low noise amplifier 1061 that amplifies a signal received through the ninth antenna 1031 and/or the tenth antenna 1032, and a multiplexer 1065 capable of separating the transmitted signal and/or the received signal.

The second TRx circuit 1023 may include one or more RFFEs (e.g., the RFFE 435 of FIG. 4B). The second TRx circuit 1023 may support a standalone mode and/or a non-standalone mode of first cellular communication. The second TRx circuit 1023 may be configured to communicate with the external electronic device 104 through a node (e.g., the first node 410) supporting first cellular communication and/or a node (e.g., the second node 420) supporting second cellular communication in a non-standalone mode of the first cellular communication. The second TRx circuit 1023 may support carrier aggregation in the standalone mode of first cellular communication. In the case of supporting carrier aggregation of first cellular communication, the second TRx circuit 1023 may be configured to communicate with the external electronic device 104 through the first node 410 and the second node 420.

The second TRx circuit 1023 may be electrically connected to at least one of the eleventh antenna 1033 or the twelfth antenna 1034. According to an example, the second TRx circuit 1023 may include a switch that may electrically connect at least one of the eleventh antenna 1033 or the twelfth antenna 1034 and at least one component (e.g., multiplexer, amplifier, and low-noise amplifier) included in the second TRx circuit 1023.

The second TRx circuit 1023 may include an amplifier 1073 that amplifies a signal received from the processor 1010, a low noise amplifier 1071 that amplifies a signal received through the eleventh antenna 1033 and/or the twelfth antenna 1034, and a multiplexer 1075 capable of separating the transmitted signal and/or the received signal.

The processor 1010 may be operatively or electrically connected to the first TRx circuit 1021 and/or the second TRx circuit 1023. The processor 1010 may control the components of the electronic device 101. For example, the processor 1010 may control components of the electronic device 101 according to one or more instructions stored in the memory (e.g., the memory 130 of FIG. 1).

The processor 1010 may transmit and/or receive data through first cellular communication and/or second cellular communication. The processor 1010 may be connected to the first node 410 and/or the second node 420. The processor 1010 may transmit user data received from an application processor (e.g., the processor 120 of FIG. 1) through first cellular communication and/or second cellular communication, and transmit user data received through first cellular communication and/or second cellular communication to the application processor 120.

The first cellular communication is any one communication method of various cellular communication methods that may be supported by the electronic device 101 and may refer, for example, to a communication method on the second network 294 of FIG. 2. For example, the first cellular communication may be a communication method using a 5th generation mobile communication method (e.g., new radio).

The second cellular communication is any one communication method of various cellular communication methods that may be supported by the electronic device (e.g., the electronic device 101 of FIG. 1) and may refer, for example, to a communication method on the first network 292 of FIG. 2. For example, the second cellular communication may be a communication method using a 4th generation mobile communication method (e.g., long term evolution).

The processor 1010 may be connected to the cellular network 400 through the first node 410 and be connected to the cellular network 400 through the second node 420. The processor 1010 may be connected to both the first node (e.g., the first node 410 of FIG. 4A) and/or the second node (e.g., the second node 420 of FIG. 4A), and transmit or receive data through the first node 410 and/or the second node 420. While the processor 1010 transmits or receives data to or from the first node 410 through resources allocated by the first node 410, the processor 1010 may transmit or receive data to or from the second node 420 through resources allocated by the second node 420.

The processor 1010 may support antenna switching for signal transmission. Antenna switching may refer to changing the antenna that transmits a signal.

An operation mode of antenna switching may be distinguished according to the number of antennas transmitting a reference signal during a specific time (or specific slot). Assuming that the electronic device 101 transmits a reference signal using four antennas (e.g., the ninth antenna 1031, the tenth antenna 1032, the eleventh antenna 1033, and the twelfth antenna 1034), the operation mode of antenna switching may include 2T4R (hereinafter, defined as a first operation mode), which is an operation mode that transmits a reference signal through two antennas during a specific time (or specific slot), and 1T4R (hereinafter, defined as a second operation mode), which is an operation mode that transmits a reference signal through one antenna during a specific time (or specific slot).

According to an example, the processor 1010 may transmit a reference signal to a cellular network (e.g., the cellular network 400 of FIG. 4A) according to either the first operation mode or the second operation mode. The cellular network 400 may receive a reference signal, and allocate resources (e.g., MCS level) required for the electronic device 101 to transmit a signal through a series of operations (e.g., channel estimation) using information included in the reference signal.

The reference signal may be transmitted through the ninth antenna 1031, the tenth antenna 1032, the eleventh antenna 1033, and/or the twelfth antenna 1034, and a transmission order of a reference signal may be a predetermined order on the electronic device 101 or an order configured by the cellular network 400.

The processor 1010 may control the first TRx circuit 1021 to transmit a reference signal through any one antenna of the ninth antenna 1031 and the tenth antenna 1032, and control the second TRx circuit 1023 to transmit a reference signal through any one antenna of the eleventh antenna 1033 and the twelfth antenna 1034 in the first operation mode.

The processor 1010 may control the first TRx circuit 1021 to transmit a reference signal through the ninth antenna 1031 in the first operation mode. The processor 1010 may control the second TRx circuit 1023 to transmit the reference signal through the eleventh antenna 1033 at substantially the same time point as the time point of transmitting a reference signal through the ninth antenna 1031.

In order to transmit a reference signal through the ninth antenna 1031, the processor 1010 may control a first switch 1043 to electrically connect the ninth antenna 1031 and the first TRx circuit 1021. The first TRx circuit 1021 may be electrically connected to the ninth antenna 1031 by the first switch 1043 and output a reference signal through the ninth antenna 1031. In order to transmit a reference signal through the eleventh antenna 1033, the processor 1010 may control a second switch 1055 to electrically connect the eleventh antenna 1033 and the second TRx circuit 1023. The second TRx circuit 1023 may be electrically connected to the eleventh antenna 1033 by the second switch 1055 and output a reference signal through the eleventh antenna 1033.

The processor 1010 may control the first TRx circuit 1021 to transmit a reference signal through the tenth antenna 1032 in the first operation mode. The processor 1010 may control the second TRx circuit 1023 to transmit the reference signal through the twelfth antenna 1034 at substantially the same time point as the time point of transmitting a reference signal through the tenth antenna 1032.

In order to transmit a reference signal through the tenth antenna 1032, the processor 1010 may control the first switch 1043 to electrically connect the tenth antenna 1032 and the first TRx circuit 1021. The first TRx circuit 1021 may be electrically connected to the tenth antenna 1032 by the first switch 1043 and output a reference signal through the tenth antenna 1032. In order to transmit a reference signal through the twelfth antenna 1034, the processor 1010 may control the second switch 1055 to electrically connect the twelfth antenna 1034 and the second TRx circuit 1023. The second TRx circuit 1023 may be electrically connected to the twelfth antenna 1034 by the second switch 1055 and output a reference signal through the twelfth antenna 1034.

The order of the reference signals described above (after transmission of a reference signal through the ninth antenna 1031 and the eleventh antenna 1033, transmission of a reference signal through the tenth antenna 1032 and the twelfth antenna 1034) is an example and may be changed in various manners. The processor 1010 may transmit a reference signal using both the first TRx circuit 1021 and the second TRx circuit 1023 in a first operation mode.

According to an example, the processor 1010 may control the first TRx circuit 1021 to transmit a reference signal using any one antenna of the ninth antenna 1031, the tenth antenna 1032, the eleventh antenna 1033, and/or the twelfth antenna 1034 in a second operation mode.

The processor 1010 may control the first TRx circuit 1021 to transmit a reference signal through the ninth antenna 1031 during a first time in the second operation mode. In order to transmit a reference signal through the ninth antenna 1031, the processor 1010 may control the first switch 1043 to electrically connect the ninth antenna 1031 and the first TRx circuit 1021. The first TRx circuit 1021 may be electrically connected to the ninth antenna 1031 according to an operation of the first switch 1043 and transmit a reference signal through the ninth antenna 1031.

The processor 1010 may control the first TRx circuit 1021 to transmit a reference signal during a second time through the tenth antenna 1032 in the second operation mode. The second time is different from the first time and may be a time that does not overlap with the first time. In order to transmit a reference signal through the tenth antenna 1032, the processor 1010 may control the first switch 1043 to electrically connect the tenth antenna 1032 and the first TRx circuit 1021. The first TRx circuit 1021 may be electrically connected to the tenth antenna 1032 according to an operation of the first switch 1043 and transmit a reference signal through the tenth antenna 1032.

The processor 1010 may control the first TRx circuit 1021 to transmit a reference signal during a third time through the eleventh antenna 1033 in the second operation mode. The third time is different from the first time and/or the second time and may be a time that does not overlap with the first time and/or the second time.

In order to transmit a reference signal through the eleventh antenna 1033, the processor 1010 may control the first switch 1043 to electrically connect a third switch 1053 and the first TRx circuit 1021, control the third switch 1053 to electrically connect the first switch 1043 and the second switch 1055, and control the second switch 1055 to electrically connect the third switch 1053 and the eleventh antenna 1033. The first TRx circuit 1021 may be electrically connected to the eleventh antenna 1033 according to an operation of the first switch 1043, the second switch 1055, and/or the third switch 1053, and transmit a reference signal through the eleventh antenna 1033.

The processor 1010 may control the first TRx circuit 1021 to transmit a reference signal during a fourth time through the twelfth antenna 1034 in the second operation mode. The fourth time is different from the first time, the second time, and/or the third time, and may be a time that does not overlap with the first time, the second time, and/or the third time.

In order to transmit a reference signal through the twelfth antenna 1034, the processor 1010 may control the first switch 1043 to electrically connect the third switch 1053 and the first TRx circuit 1021, control the third switch 1053 to electrically connect the first switch 1043 and the second switch 1055, and control the second switch 1055 to electrically connect the third switch 1053 and the twelfth antenna 1034. The first TRx circuit 1021 may be electrically connected to the twelfth antenna 1034 according to an operation of the first switch 1043, the second switch 1055, and/or the third switch 1053, and transmit a reference signal through the twelfth antenna 1034.

The order of the reference signals described above is an example and may be changed in various manners. The processor 1010 may transmit a reference signal using the first TRx circuit 1021 in the second operation mode. The processor 1010 may not use a second communication circuit 1022 in the second operation mode.

As described above with reference to FIG. 6, the first operation mode may be an operation mode that has relatively less influence on other antennas (e.g., the sixth antenna 621 of FIG. 6) connected to the second TRx circuit 1023 compared to the second operation mode.

With reference to the above operation, a thirteenth antenna 1035 may be affected at least four times due to transmission of a reference signal in the second operation mode. For example, the thirteenth antenna 1035 may be affected twice by the state change (once) of the third switch 1053 and the second switch 1055 for transmission of a reference signal through the eleventh antenna 1033 and the state change (once) of the third switch 1053 and the second switch 1055 for transmission of a reference signal through the twelfth antenna 1034.

However, the thirteenth antenna 1035 may be affected at least once due to transmission of a reference signal in the first operation mode. For example, the thirteenth antenna 1035 may be affected once by a state change (once) of the second switch 1055 for transmission of a reference signal through the eleventh antenna 1033.

Therefore, an error rate of a signal in a frequency band different from the frequency band of the reference signal due to transmission of a reference signal using the first operation mode may be lower than that of a signal in a frequency band different from the frequency band of the reference signal due to transmission of a reference signal using the second operation mode. However, power consumption according to signal transmission using the first operation mode may be greater than power consumption according to signal transmission using the second operation mode. Hereinafter, a reference signal transmission method that may reduce power consumption while reducing the influence of signals in a frequency band different from the frequency band of the reference signal according to transmission of a reference signal will be described.

The processor 1010 may receive information indicating a combination of frequency bands to be used for cellular communication from the cellular network 400.

The processor 1010 may receive information indicating a combination of frequency bands to be used for cellular communication from the cellular network 400 while connected to the cellular network 400 through the first node 410 and the second node 420. Information indicating the combination of frequency bands to be used for cellular communication may be included in an RRC reconfiguration message or a UE capability inquiry message received in a process in which the electronic device 101 attaches to the cellular network 400.

According to an example, the processor 1010 may receive various signals (e.g., UE capability inquiry message, RRC reconfiguration message) in a process of attaching to the cellular network 400. The processor 1010 may complete a connection procedure with the first node 410 and/or the second node 420 using information indicating the combination of frequency bands. According to an example, the processor 1010 may receive a signal including information indicating a combination of a first frequency band and a second frequency band, be connected to the first node 410 through the first frequency band, and be connected to the second node 420 through the second frequency band.

The processor 1010 may identify whether the combination of frequency bands included in the information indicating the combination of frequency bands is a combination of designated frequency bands.

The combination of designated frequency bands may refer to a combination of a frequency band of a reference signal and a frequency band of a received signal interfered by transmission of a reference signal. According to an example, the combination of designated frequency bands may include a combination of a first frequency band that transmits a reference signal and a second frequency band interfered by transmission of a reference signal.

The processor 1010 may identify that the combination of frequency bands included in information indicating the combination of frequency bands is a combination of the designated frequency bands, and transmit UE capability information including parameters related to transmission of a reference signal of the first frequency band among the combination of frequency bands.

The processor 1010 may transmit UE capability information including information indicating a second operation mode in which one communication circuit (e.g., the first TRx circuit 1021) of the first TRx circuit 1021 and a second communication circuit 1013 transmits a reference signal to the cellular network 400. The cellular network 400 may receive UE capability information transmitted by the electronic device 101 and perform an operation for receiving a reference signal to be transmitted by the electronic device 101. The cellular network 400 may identify that the electronic device 101 transmits once a reference signal with reference to (or based on) information indicating the second operation mode included in the UE capability information.

The processor 1010 may transmit UE capability information to the cellular network 400 and then perform a series of operations for transmitting a reference signal. The processor 1010 may switch or maintain the state of the first TRx circuit 1021 and the second TRx circuit 1023 to a ready state.

The state of the first TRx circuit 1021 and the second TRx circuit 1023 in a ready state may refer to a state that enables the first TRx circuit 1021 and the second TRx circuit 1023 to transmit a reference signal.

In order for the first TRx circuit 1021 and the second TRx circuit 1023 to transmit a reference signal, the processor 1010 may configure (or switch) components that may process a signal (e.g., an amplifier that amplifies a signal) included in the first TRx circuit 1021 and the second TRx circuit 1023 to an activated state.

The processor 1010 may configure an amplifier 1063 included in the first TRx circuit 1021 to the activated state and configure an amplifier 1073 included in the second TRx circuit 1023 to the activated state. Configuring the amplifier 1073 included in the second TRx circuit 1023 to the activated state may be to enable the second TRx circuit 1023 to transmit a reference signal through the eleventh antenna 1033 and/or the twelfth antenna 1034.

When performing a series of operations for transmitting a reference signal, in order to activate the first operation mode, the processor 1010 may load a parameter (e.g., NV parameter) corresponding to the first operation mode or configuration information (e.g., EFS) corresponding to the first operation mode onto the memory (e.g., the memory 130 of FIG. 1), and switch or maintain the state of the first TRx circuit 1021 and the second TRx circuit 1023 to a ready state using parameters or configuration information corresponding to the first operation mode. The parameters corresponding to the first operation mode or the configuration information corresponding to the first operation mode may be information that enables the first TRx circuit 1021 and the second TRx circuit 1023 to be in a ready state.

The processor 1010 may control the first TRx circuit 1021 and the second TRx circuit 1023 to transmit a reference signal.

The processor 1010 has transmitted UE capability information including information indicating a second operation mode in which one communication circuit (e.g., the first TRx circuit 1021) of the first TRx circuit 1021 and the second communication circuit 1013 transmits a reference signal to the cellular network 400, but when the processor 1010 transmits a reference signal, the processor 1010 may control the first TRx circuit 1021 and the second TRx circuit 1023 to transmit the reference signal. Transmitting a reference signal using both the first TRx circuit 1021 and the second TRx circuit 1023 may be intended to reduce (or prevent) may be to reduce (or prevent) interruption of reception of signals in frequency bands (or deterioration in the quality of signals in other frequency bands) different from the reference signal.

When transmitting a reference signal, the processor 1010 may transmit a reference signal according to the transmission order of a reference signal corresponding to the second operation mode. Transmitting a reference signal according to the transmission order of a reference signal corresponding to the second operation mode may be an operation considering that the cellular network 400 recognizes (or identifies, determines) that the electronic device 101 is transmitting a reference signal in the second operation mode. According to an example, despite the cellular network 400 recognizes (or identifies, determines) that the electronic device 101 is transmitting a reference signal in the second operation mode, in the case of transmitting a reference signal (or in the case of transmitting substantially simultaneously the reference signal through two antennas) according to the transmission order of the reference signal corresponding to the first operation mode, the cellular network 400 may not receive a reference signal, or even if the cellular network 400 receives a reference signal, it may be difficult that the cellular network 400 appropriately performs an operation based on the reference signal. Accordingly, the processor 1010 may transmit a reference signal according to the transmission order of the reference signal corresponding to the second operation mode.

According to an example, in the case that the transmission order of the reference signal corresponding to the second operation mode is configured (or determined) to the order of transmission of a reference signal through the ninth antenna 1031, transmission of a reference signal through the tenth antenna 1032, transmission of a reference signal through the eleventh antenna 1033, and transmission of a reference signal through the twelfth antenna 1034, the processor 1010 may control the first TRx circuit 1021 to transmit a reference signal through the ninth antenna 1031, control the second TRx circuit 1023 to transmit a reference signal through the eleventh antenna 1033, control the first TRx circuit 1021 to transmit a reference signal through the tenth antenna 1032, and control the second TRx circuit 1023 to transmit a reference signal through the twelfth antenna 1034.

In the case of transmitting signals other than the reference signal, the processor 1010 may transmit a signal using one TRx circuit (e.g., the first TRx circuit 1021). According to an example, in the case that a signal needs to be transmitted through a physical uplink control channel (PUCCH) or a physical uplink shared channel (PUSCH), the processor 1010 may control the first TRx circuit 1021 to transmit a signal. In the case of transmitting a signal using one TRx circuit, the other TRx circuit (e.g., the second TRx circuit 1023) may not transmit a signal, and the amplifier 1073 that amplifies a signal to be transmitted may be switched (or maintained) to a deactivated state.

The processor 1010 may control the first TRx circuit 1021 to transmit a signal through one of the ninth antenna 1031 and the tenth antenna 1032 in the second operation mode.

The processor 1010 may receive a signal received through at least one of the ninth antenna 1031 or the tenth antenna 1032 from the first TRx circuit 1021. The first TRx circuit 1021 may control the low-noise amplifier 1061 to amplify a signal received through at least one of the ninth antenna 1031 or the tenth antenna 1032.

The processor 1010 may receive a signal received through at least one of the eleventh antenna 1033 or the twelfth antenna 1034 from the second TRx circuit 1023. The second TRx circuit 1023 may control the low-noise amplifier 1071 to amplify a signal received through at least one of the eleventh antenna 1033 or the twelfth antenna 1034.

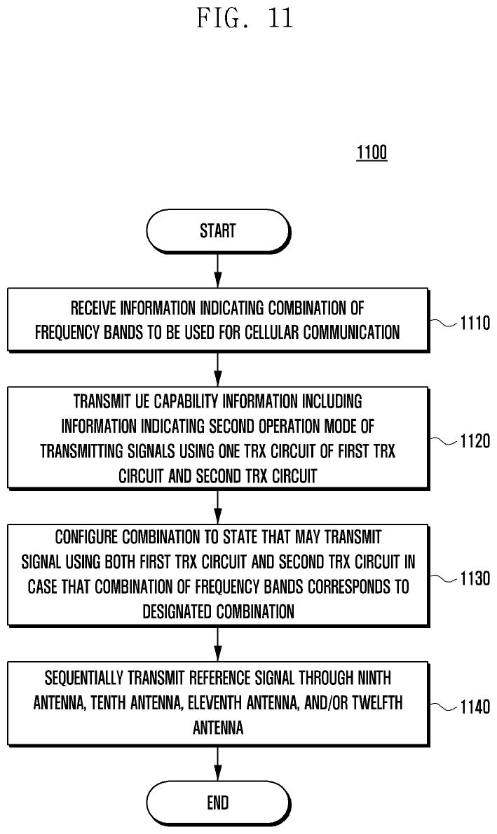

FIG. 11 is a flowchart illustrating an example method of operating an electronic device according to various embodiments.

In operation 1110, the electronic device (e.g., the electronic device 101 of FIG. 10) may receive information indicating a combination of frequency bands to be used for cellular communication from a cellular network.

The electronic device 101 may receive information indicating a combination of frequency bands to be used for cellular communication from the cellular network 400 while connected to the cellular network 400 through the first node 410 and the second node 420. Information indicating the combination of frequency bands to be used for cellular communication may be included in an RRC reconfiguration message or UE capability inquiry message received in a process in which the electronic device 101 attaches to the cellular network 400.

According to an example, the electronic device 101 may receive various signals (e.g., UE capability inquiry message, RRC reconfiguration message) in the process of attaching to the cellular network 400. The electronic device 101 may complete a connection procedure with the first node 410 and/or the second node 420 using information indicating the combination of frequency bands. According to an example, the electronic device 101 may receive a signal including information indicating a combination of a first frequency band and a second frequency band, be connected to the first node 410 through the first frequency band, and be connected to the second node 420 through the second frequency band.

In operation 1120, the electronic device 101 may transmit UE capability information including information indicating a second operation mode of transmitting signals using one TRx circuit (e.g., the first TRx circuit 1021 of FIG. 10) of the first TRx circuit (e.g., the first TRx circuit 1021 of FIG. 10) and the second TRx circuit (e.g., the second TRx circuit 1023 of FIG. 10) to the cellular network.

The electronic device 101 may transmit UE capability information including information indicating a second operation mode in which one communication circuit (e.g., the first TRx circuit 1021) of the first TRx circuit 1021 and the second communication circuit 1013 transmits a reference signal to the cellular network 400. The cellular network 400 may perform an operation of receiving UE capability information transmitted by the electronic device 101 and receiving a reference signal to be transmitted by the electronic device 101. The cellular network 400 may identify that the electronic device 101 transmits a reference signal once with reference to (or based on) information indicating the second operation mode included in the UE capability information.

The electronic device 101 may identify whether the combination of frequency bands included in the information indicating the combination of frequency bands is a combination of the designated frequency bands.

The combination of designated frequency bands may refer, for example, to a combination of a frequency band of a reference signal and a frequency band of a received signal interfered by transmission of a reference signal. According to an example, the combination of designated frequency bands may include a combination of a first frequency band that transmits a reference signal and a second frequency band interfered by transmission of a reference signal.

In operation 1130, in the case that the combination of frequency bands corresponds to the designated combination, the electronic device 101 may configure the combination to a state that may transmit a signal using both the first TRx circuit 1021 and the second TRx circuit 1023.

The electronic device 101 may transmit UE capability information to the cellular network 400 and then perform a series of operations for transmitting a reference signal. The electronic device 101 may switch or maintain the state of the first TRx circuit 1021 and the second TRx circuit 1023 to a ready state.

The state of the first TRx circuit 1021 and the second TRx circuit 1023 in a ready state may refer to a state that enables the first TRx circuit 1021 and the second TRx circuit 1023 to transmit a reference signal.

In order for the first TRx circuit 1021 and the second TRx circuit 1023 to transmit a reference signal, the electronic device 101 may configure (or switch) components that may process a signal (e.g., an amplifier that amplifies a signal) included in the first TRx circuit 1021 and the second TRx circuit 1023 to an activated state.

The electronic device 101 may configure the amplifier 1063 included in the first TRx circuit 1021 to the activated state and configure the amplifier 1073 included in the second TRx circuit 1023 to the activated state. Configuring the amplifier 1073 included in the second TRx circuit 1023 to the activated state may be to enable the second TRx circuit 1023 to transmit a reference signal through an eleventh antenna 1033 and/or a twelfth antenna 1034.

When performing a series of operations for transmitting a reference signal, in order to activate a first operation mode, the electronic device 101 may load a parameter (e.g., NV parameter) corresponding to the first operation mode or configuration information (e.g., EFS) corresponding to the first operation mode onto the memory (e.g., the memory 130 of FIG. 1), and switch or maintain the state of the first TRx circuit 1021 and the first TRx circuit 1021 to a ready state using parameters or configuration information corresponding to the first operation mode. The parameters corresponding to the first operation mode or the configuration information corresponding to the first operation mode may be information that enables the first TRx circuit 1021 and the second TRx circuit 1023 to be in a ready state.

In operation 1140, the electronic device 101 may control the first TRx circuit 1021 and the second TRx circuit 1023 to sequentially transmit a reference signal through the ninth antenna 1031, the tenth antenna 1032, the eleventh antenna 1033, and/or the twelfth antenna 1034.

The electronic device 101 may control the first TRx circuit 1021 and the second TRx circuit 1023 to transmit a reference signal.

The electronic device 101 has transmitted UE capability information including information indicating a second operation mode in which one communication circuit (e.g., the first TRx circuit 1021) of the first TRx circuit 1021 and the second communication circuit 1013 transmits a reference signal to the cellular network 400, but when transmitting a reference signal, the electronic device 101 may control the first TRx circuit 1021 and the second TRx circuit 1023 to transmit a reference signal. Transmitting a reference signal using both the first TRx circuit 1021 and the second TRx circuit 1023 may be to reduce (or prevent) interruption of reception of signals in frequency bands (or deterioration of the quality of signals in other frequency bands) different from that of the reference signal.

When transmitting a reference signal, the electronic device 101 may transmit a reference signal according to the transmission order of the reference signals corresponding to the second operation mode. Transmitting a reference signal according to the transmission order of the reference signals corresponding to the second operation mode may be an operation considering that the cellular network 400 recognizes (or identifies, determines) that the electronic device 101 is transmitting a reference signal in the second operation mode. According to an example, despite the cellular network 400 recognizes (or identifies, determines) that the electronic device 101 is transmitting a reference signal in the second operation mode, in the case of transmitting a reference signal (or in the case of transmitting substantially simultaneously the reference signal through two antennas) according to the transmission order of the reference signal corresponding to the first operation mode, the cellular network 400 may not receive a reference signal, or even if the cellular network 400 receives a reference signal, it may be difficult that the cellular network 400 appropriately performs an operation based on the reference signal. Accordingly, the electronic device 101 may transmit a reference signal according to the transmission order of the reference signal corresponding to the second operation mode.

According to an example, in the case that the transmission order of the reference signal corresponding to the second operation mode is configured (or determined) to the order of transmission of a reference signal through the ninth antenna 1031, transmission of a reference signal through the tenth antenna 1032, transmission of a reference signal through the eleventh antenna 1033, and transmission of a reference signal through the twelfth antenna 1034, the electronic device 101 may control the first TRx circuit 1021 to transmit a reference signal through the ninth antenna 1031, control the second TRx circuit 1023 to transmit a reference signal through the eleventh antenna 1033, control the first TRx circuit 1021 to transmit a reference signal through the tenth antenna 1032, and control the second TRx circuit 1023 to transmit a reference signal through the twelfth antenna 1034.

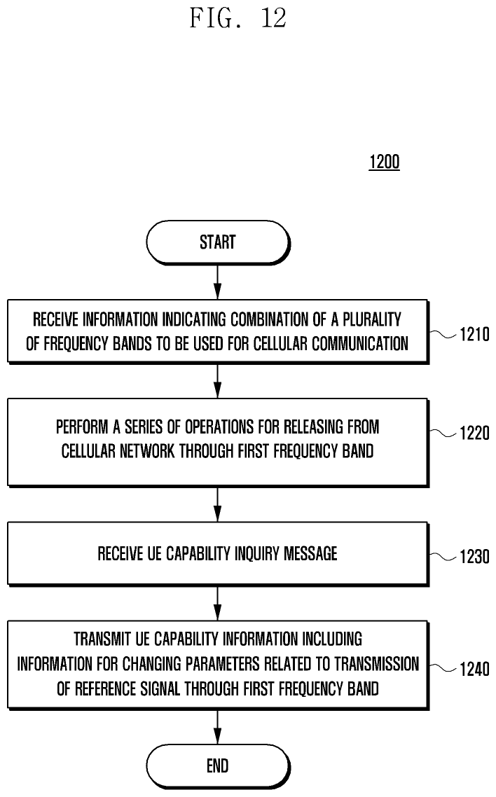

FIG. 12 is a flowchart 1200 illustrating an example method of operating an electronic device according to various embodiments.

In operation 1210, the electronic device (e.g., the electronic device 101 of FIG. 5) may receive information indicating a combination of a plurality of frequency bands to be used for cellular communication.

The electronic device 101 may receive an RRC reconfiguration message from the cellular network 440 after a connection procedure with the cellular network (e.g., the cellular network 400 of FIG. 4) is completed.

The RRC reconfiguration message may include information indicating a combination of a plurality of frequency bands to be used by the electronic device 101 when using cellular communication, and parameters related to transmission of a reference signal.

The parameters related to the reference signal may indicate various parameters including a transmission time point of the reference signal (e.g., information on a slot capable of transmitting a reference signal), a transmission period of the reference signal, and/or an operation mode (e.g., first operation mode or second operation mode) related to transmission of the reference signal.

The electronic device 101 may receive a signal including parameters related to the reference signal and transmit a reference signal to the first node 410 using the parameters related to the reference signal. The first node 410 may receive a reference signal, and allocate resources (e.g., MCS level) required for the electronic device 101 to transmit the signal through a series of operations (e.g., channel estimation) using information included in the reference signal. The electronic device 101 may transmit a signal to the first node 410 using resources allocated by the first node 410 (or the cellular network 400).

In operation 1220, the electronic device 101 may perform a series of operations for releasing from the cellular network 400 through the first frequency band.

In the case that a combination of a plurality of frequency bands is a combination of designated frequency bands, the electronic device 101 may perform a series of operations for releasing from the cellular network 400 through one frequency band.

The combination of designated frequency bands may refer to a combination of a frequency band of a reference signal and a frequency band of a received signal interfered by transmission of a reference signal. According to an example, the combination of designated frequency bands may include a combination of a first frequency band that transmits a reference signal and a second frequency band interfered by transmission of a reference signal.

In the case that a connection state to the cellular network 400 through the first frequency band is an RRC connected state, it may be difficult that the electronic device 101 transmits UE capability information. Accordingly, in order to transmit UE capability information, the electronic device 101 may perform a series of operations that release a connection (or RRC connection) with the first node 410 (or the cellular network 400) connected through the first frequency band.

According to an example, the electronic device 101 may transmit, to the first node 410, information (e.g., information indicating that a channel quality indicator (CQI) is 0 or an SCG failure signal) indicating that a quality of a signal transmitted through the first frequency band is not appropriate for performing cellular communication through the first frequency band. The first node 410 that has received information indicating that the quality of the signal transmitted through the first frequency band is not appropriate for performing cellular communication through the first frequency band may release connection through the first frequency band with the electronic device 101.

According to an example, the electronic device 101 may not transmit information (e.g., measurement report) indicating the quality of the signal in the first frequency band to the first node 410 (or the cellular network 400) during a designated time. The first node 410 that has not received information indicating the quality of the signal in the first frequency band during a predetermined time or more may release connection with the electronic device 101 through the first frequency band.

According to an example, the electronic device 101 may not perform a decoding operation of a control signal (e.g., PDSCH) received through the first frequency band. In the case of not performing a decoding operation of the control signal, the electronic device 101 may not smoothly perform connection to the first node 410 through the first frequency band, and the first node 410 may release connection to the electronic device 101 through the first frequency band.

In operation 1230, the electronic device 101 may receive a UE capability inquiry message from the cellular network 400.

In operation 1240, the electronic device 101 may transmit UE capability information including information for changing parameters related to transmission of a reference signal through the first frequency band.

The electronic device 101 may transmit UE capability information including parameters related to transmission of a reference signal in the first frequency band.

Changing operation related to transmission of a reference signal in the first frequency band may refer to various operations for preventing and/or reducing a quality of a signal in a second frequency band from being deteriorated due to transmission of a reference signal in the first frequency band.

According to an example, a change of operation related to transmission of a reference signal in the first frequency band may include changing an operation mode of antenna switching for transmission of a reference signal.

Antenna switching may refer to changing an antenna that transmits a reference signal. According to an example, the electronic device 101 for supporting antenna switching may transmit a reference signal to the cellular network 400 through a second antenna 443 at a specific time, and transmit a reference signal to the cellular network 400 through a third antenna 445 at another specific time.

The operation mode of antenna switching may be distinguished according to the number of antennas transmitting a reference signal during a specific time (or specific slot). Assuming that the electronic device 101 transmits a reference signal using four antennas, an operation mode of antenna switching may include 2T4R (hereinafter, defined as a first operation mode), which is an operation mode that transmits four reference signals for each two TRx circuits (e.g., the first TRx circuit 601, the second TRx circuit 611 of FIG. 6) through two antennas during a specific time (or specific slot) and 1T4R (hereinafter, defined as a second operation mode), which is an operation mode that transmits four reference signals for one TRx circuit (e.g., the first TRx circuit 601 of FIG. 6) through four antennas during a specific time (or specific slot).

According to an example, in the case that the electronic device 101 operates in the first operation mode, at a specific time, the first TRx circuit 601 may transmit a reference signal through a first antenna 605, and the second TRx circuit 611 may transmit a reference signal through a third antenna 623, at another specific time, the first TRx circuit 601 may transmit a reference signal through a second antenna 607, and the second TRx circuit 611 may transmit a reference signal through a fourth antenna 625.

According to an example, in the case that the electronic device 101 operates in the second operation mode, the first TRx circuit 601 may transmit a reference signal through the first antenna 605 at a specific time, the first TRx circuit 601 may transmit a reference signal through the second antenna 607 at another specific time, the first TRx circuit 601 may transmit a reference signal through the third antenna 623 at another specific time, and the first TRx circuit 601 may transmit a reference signal through the fourth antenna 625 at another specific time.

A change in the operation mode of antenna switching may cause a change in the number of the state change of the switch (e.g., the switch 437 of FIG. 4B) connected to a plurality of antennas 530, and the electronic device 101 may perform a series of operations of changing the operation mode of antenna switching so as to reduce the number of state change of the switch 437.

The electronic device 101 may transmit a UE capability message for changing the operation mode of antenna switching to the cellular network 400. According to an example, the electronic device 101 may transmit a UE capability message including information indicating an operation mode of antenna switching that reduces the number of the state change of the switch 437 electrically connected to the plurality of antennas 530 to the cellular network 400. Information indicating an operation mode of antenna switching may be included in a SupportedSRS-TxPortSwitch field of the UE capability message.

The first node 410 (or the cellular network 400) that has received a UE capability message including information indicating an operation mode of antenna switching may determine an operation mode of antenna switching to be performed by the electronic device 101 with reference to information indicating the operation mode of antenna switching, and transmit information indicating the determined operation mode to the electronic device 101. Information indicating the determined operation mode may be included in the RRC reconfiguration message, and the electronic device 101 that has received the information indicating the determined operation mode may transmit a reference signal through the first frequency band according to the determined operation mode.

According to an example, a change of operation related to transmission of a reference signal in the first frequency band may include configuring (or changing) the transmission period of the reference signal to be relatively long.

The electronic device 101 may determine a transmission period of the reference signal based on the quality of the second frequency band. According to an example, the electronic device 101 may identify a quality in the second frequency band based on various signals (e.g., signals received during an attachment process with the cellular network 400) from the second node 420 through the second frequency band. According to an example, the electronic device 101 may identify a quality of the second frequency band based on characteristics of resources (e.g., MCS level or throughput) allocated to transmission or reception of signals through the second frequency band. The higher the MCS level or throughput, the higher the quality of the second frequency band may be.

By configuring (or changing) the transmission period of the reference signal to be relatively long, the electronic device 101 may reduce the number of reference signals transmitted during a specific time. The electronic device 101 may transmit a UE capability message including information indicating a transmission period of a reference signal configured to be relatively long to the cellular network 400. Information indicating the transmission period of the reference signal may be included in a TxSwitchImpactTo Rx field, which is a subfield of a SupportedSRS-TxPortSwitch field of the UE capability message.

The first node 410 (or the cellular network 400) that has received the UE capability message including information indicating the transmission period of the reference signal may determine a transmission period of the reference signal to be performed by the electronic device 101 with reference to information indicating the transmission period of the reference signal and transmit information indicating the determined period to the electronic device 101. Information indicating the determined period may be included in the RRC reconfiguration message, and the electronic device 101 that has received information indicating the determined period may transmit a reference signal through the first frequency band according to the determined period.

According to an example, a change of operation related to transmission of a reference signal in the first frequency band may include configuring (or changing) the number of transmissions of the reference signal to be relatively large during a designated time (or the size of a designated slot).

Increasing the number of transmissions of the reference signal during a designated time may refer, for example, to increasing the time (or the number of slots) that does not transmit a reference signal. According to an example, in the case that two reference signals are transmitted in one slot, the number (e.g., 18) of slots that do not transmit a reference signal may be greater than the number (e.g., 16) of slots that do not transmit a reference signal in the case that one reference signal is transmitted in one slot. Accordingly, because the time required for transmitting a reference signal may be reduced, a quality of a signal received through another frequency band due to transmission of the reference signal may be reduced relatively little.

The electronic device 101 may transmit a UE capability message including information indicating the number of transmissions of a relatively largely configured (or changed) reference signal per unit time (or per slot) to the cellular network 400. Information indicating the number of transmissions of the reference signal per unit time (or per slot) may be included in a TxSwitchImpactTo Rx field, which is a subfield of a SupportedSRS-TxPortSwitch field of the UE capability message.

The first node 410 (or the cellular network 400) that has received the UE capability message including the number of transmissions of the reference signal per unit time (or per slot) may determine the number of transmissions of the reference signal to be performed by the electronic device 101 with reference to the number of transmissions of the reference signal per unit time (or per slot) and transmit information indicating the determined number of transmissions to the electronic device 101. Information indicating the determined number of transmissions may be included in the RRC reconfiguration message, and the electronic device 101 that has received information indicating the determined number of transmissions may transmit a reference signal through the first frequency band according to the determined number of transmissions.

According to an example, a change of operation related to transmission of a reference signal in the first frequency band may include configuring a time point of transmission of a reference signal through the first frequency band differently from a time point (or a time point of measuring a quality of a signal received through the second frequency band) transmitting information indicating a quality of a signal through the second frequency band.

By configuring a time point of transmission of a reference signal through the first frequency band differently from a time point of transmitting information indicating a quality of a signal through the second frequency band (or a time point of measuring a quality of the signal received through the second frequency band), the electronic device 101 transmits the reference signal through the first frequency band at a time point at which the quality of the signal in the second frequency band is transmitted (or a time point of measuring the quality of the signal received through the second frequency band), thereby preventing and/or reducing the quality of the received signal from being deteriorated and preventing and/or reducing a situation in which a resource of a relatively low performance is allocated.

The electronic device 101 may transmit a UE capability message including information indicating a transmission time point of the reference signal through the first frequency band configured differently from a time point of transmitting information indicating a quality of a signal through the second frequency band (or a time point of measuring a quality of a signal received through the second frequency band) to the cellular network 400. Information indicating the transmission time point of the reference signal through the first frequency band may be included in a TxSwitchImpactToRx field, which is a subfield of a SupportedSRS-TxPortSwitch field of the UE capability message.

The first node 410 (or the cellular network 400) that has received a UE capability message including information indicating the transmission time of the reference signal through the first frequency band configured differently from a time point of transmitting information indicating a quality of a signal through the second frequency band (or a time point of measuring a quality of a signal received through the second frequency band) may determine a transmission time point of the reference signal to be performed by the electronic device 101 and transmit information indicating the determined transmission time point to the electronic device 101. The information indicating the determined transmission time point may be included in an RRC reconfiguration message, and the electronic device 101 that has received the information indicating the determined transmission time point may transmit a reference signal through the first frequency band according to the determined transmission number.

According to an example, a change of operation related to transmission of a reference signal in the first frequency band may include configuring not to transmit a reference signal through the first frequency band.

In the case that the reference signal is not transmitted through the first frequency band, deterioration in a quality of a signal received through the second frequency band may be prevented and/or reduced.

In order to not transmit a reference signal through the first frequency band, the electronic device 101 may transmit a UE capability message indicating that transmission of a reference signal through the first frequency band is not supported to the cellular network 400. Information indicating that transmission of a reference signal through the first frequency band is not supported may be included in the TxSwitchImpactToRx field, which is a subfield of a SupportedSRS-TxPortSwitch field of the UE capability message.

The first node 410 (or the cellular network 400) that has received a UE capability message indicating that transmission of a reference signal through the first frequency band is not supported may determine the electronic device 101 not to transmit a reference signal and transmit information indicating not to transmit a reference signal to the electronic device 101. Information indicating not to transmit a reference signal may be included in the RRC reconfiguration message, and the electronic device 101 may not transmit a reference signal through the first frequency band. The first node 410 may allocate resources to be used by the electronic device 101 using a reference signal previously received through the first frequency band.

The electronic device 101 may reduce (or prevent) deterioration of a quality of the signal received through the second frequency band due to transmission of a reference signal through the first frequency band using the method described above, thereby reducing (or preventing) a situation in which resources of a relatively low second frequency band are allocated.

According to an example, the electronic device 101 may transmit UE capability information to the cellular network 400 through the first node 410, as in the manner described above. The first node 410 (or the cellular network 400) may transmit an RRC reconfiguration message including parameters related to transmission of a reference signal through the first frequency band to the electronic device 101 with reference to the UE capability information.

An electronic device according to an example embodiment may include: a plurality of antennas including a first antenna, a second antenna, a third antenna, and a fourth antenna; a first TRx circuit electrically connected to at least one of the first antenna, the second antenna, the third antenna, or the fourth antenna; a second TRx circuit electrically connected to at least one of the first antenna, the second antenna, the third antenna, or the fourth antenna; a memory; at least one processor, comprising processing circuitry, operatively connected to the first TRx circuit and the second circuit. At least one processor, individually and/or collectively, may be configured to control the electronic device to: receive information indicating a combination of frequency bands to be used for cellular communication from a cellular network; transmit UE capability information including information indicating a second operation mode of transmitting a signal to the outside using one of the first TRx circuit and the second TRx circuit to the cellular network; based on a combination of the frequency bands included in information indicating the frequency band received from the cellular network corresponding to a designated combination, transmit signals using both the first TRx circuit and the second TRx circuit; sequentially transmit a reference signal through the first antenna, the second antenna, the third antenna, and the fourth antenna.

In the electronic device according to an example embodiment, at least one processor, individually and/or collectively may be configured to control the first TRx circuit and the second TRx circuit to transmit the reference signal according to the transmission order of the reference signal corresponding to the second operation mode.

In the electronic device according to an example embodiment, at least one processor, individually and/or collectively, may be configured to: control the first TRx circuit to transmit the reference signal through the first antenna during a first time; control the second TRx circuit to transmit the reference signal through the second antenna during a second time; control the first TRx circuit to transmit the reference signal through the third antenna during a third time; and control the second TRx circuit to transmit the reference signal through the fourth antenna during a fourth time.

In the electronic device according to an example embodiment, a state that may transmit a signal using both the first TRx circuit and the second TRx circuit may include a state in which an amplifier that amplifies a signal included in the first TRx circuit and the second TRx circuit is configured to an activated state.

In the electronic device according to an example embodiment, in the second operation mode, at least one processor, individually and/or collectively, may be configured to control the first TRx circuit to transmit signals other than the reference signal through a physical uplink control channel (PUCCH) or a physical uplink shared channel (PUSCH).

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a plurality of antennas;
a communication circuit electrically connected to the plural antennas; and
at least one communication processor, comprising processing circuitry, operably connected to the communication circuit,
wherein at least one processor, individually and/or collectively, is configured to control the electronic device to:
receive information indicating a combination of frequency bands to be used for cellular communication from a cellular network;
transmit, based on the combination of frequency bands being a combination of designated frequency bands, to the cellular network, user equipment (UE) capability information including information for changing an operation related to transmission of a reference signal of a first frequency band among the combination of frequency bands;
receive, from the cellular network, a signal including parameters related to transmission of a reference signal configured based on the information for changing the operation related to transmission of a reference signal; and
transmit a reference signal based on the parameters related to transmission of a reference signal.

2. The electronic device of claim 1, wherein the UE capability information includes information for changing a number of antennas transmitting a reference signal during a specified time among the plural antennas.

3. The electronic device of claim 1, wherein the UE capability information includes information for adjusting a transmission periodicity of a reference signal.

4. The electronic device of claim 1, wherein the UE capability information includes information for changing a number of transmissions of a reference signal during a specified time.

5. The electronic device of claim 1, wherein the UE capability information includes information for setting a transmission time of a signal reporting a signal quality of a second frequency band to be different from a transmission time of a reference signal.

6. The electronic device of claim 1, wherein the combination of designated frequency bands includes a combination of a frequency band of a reference signal and a frequency band of a reception signal configured to receive interference from transmission of the reference signal.

7. The electronic device of claim 1, wherein based on a signal indicating a change in operation related to transmission of a reference signal not being received after transmission of the UE capability information, the at least one communication processor, individually and/or collectively, is configured to:
perform a series of operations to release a connection with the cellular network through the first frequency band to release the connection with the cellular network through the first frequency band;
receive a UE capability inquiry message from the cellular network while connecting again to the cellular network through the first frequency band; and
transmit UE capability information including information for changing the operation related to transmission of a reference signal to the cellular network.

8. The electronic device of claim 7, wherein at least one communication processor, individually and/or collectively, is configured to control the electronic device to transmit information indicating that a signal quality of the first frequency band is lower than a threshold to release the connection with the cellular network through the first frequency band.

9. The electronic device of claim 1, wherein:
the UE capability information includes information indicating that transmission of a reference signal is not supported; and
at least one communication processor, individually and/or collectively, is configured to control the electronic device to: receive information related to resource allocation determined based on a previous reference signal from the cellular network, and transmit and/or receive data through the first frequency band using allocated resources.

10. A method of operating an electronic device, comprising:
receiving information indicating a combination of frequency bands to be used for cellular communication from a cellular network;
transmitting, based on the combination of frequency bands being a combination of designated frequency bands, to the cellular network, user equipment (UE) capability information including information for changing an operation related to transmission of a reference signal of a first frequency band among the combination of frequency bands;
receiving, from the cellular network, a signal including parameters related to transmission of a reference signal configured based on the information for changing the operation related to transmission of a reference signal; and
transmitting a reference signal based on the parameters related to transmission of a reference signal.

11. The method of claim 10, wherein the UE capability information includes information for changing a number of antennas transmitting a reference signal during a specified time among plural antennas of the electronic device.

12. The method of claim 10, wherein the UE capability information includes information for adjusting a transmission periodicity of a reference signal.

13. The method of claim 10, wherein the UE capability information includes information for changing a number of transmissions of a reference signal during a specified time.

14. The method of claim 10, wherein the UE capability information includes information for setting a transmission time of a signal reporting a signal quality of a second frequency band to be different from a transmission time of a reference signal.

15. The method of claim 10, wherein the combination of designated frequency bands includes a combination of a frequency band of a reference signal and a frequency band of a reception signal configured to receive interference from transmission of the reference signal.

16. An electronic device, comprising:
a plurality of antennas including a first antenna, a second antenna, a third antenna, and a fourth antenna;
a first TRx circuit electrically connected to at least one of the first antenna, the second antenna, the third antenna, or the fourth antenna;
a second TRx circuit electrically connected to at least one of the first antenna, the second antenna, the third antenna, or the fourth antenna;
a memory; and
at least one processor, comprising processing circuitry, operatively connected to the first TRx circuit and the second TRx circuit,
wherein, at least one processor, individually and/or collectively, is configured to control the electronic device to:
receive, from a cellular network, information indicating a combination of frequency bands to be used for cellular communication,
transmit, to the cellular network, user equipment (UE) capability information including information indicating a second operation mode that transmits a signal to the outside using one TRx circuit of the first TRx circuit and the second TRx circuit,
configure, based on a combination of the frequency bands included in information indicating the frequency band received from the cellular network corresponding to a designated combination, the combination to a state that transmits a signal using both the first TRx circuit and the second TRx circuit, and
sequentially transmit a reference signal through the first antenna, the second antenna, the third antenna, and the fourth antenna.

17. The electronic device of claim 16, wherein at least one processor, individually and/or collectively, is configured to control the first TRx circuit and the second TRx circuit to transmit the reference signal according to a transmission order of a reference signal corresponding to the second operation mode.

18. The electronic device of claim 17, wherein at least one processor, individually and/or collectively, is configured to control:
the first TRx circuit to transmit the reference signal through the first antenna during a first time,
the second TRx circuit to transmit the reference signal through the second antenna during a second time,
the first TRx circuit to transmit the reference signal through the third antenna during a third time, and
the second TRx circuit to transmit the reference signal through the fourth antenna during a fourth time.

19. The electronic device of claim 16, wherein a state that transmits a signal using both the first TRx circuit and the second TRx circuit comprises a state in which an amplifier configured to amplify a signal included in the first TRx circuit and the second TRx circuit is configured to an activated state.

20. The electronic device of claim 16, at least one processor, individually and/or collectively, is configured to control the first TRx circuit to transmit signals other than the reference signal through a physical uplink control channel (PUCCH) or a physical uplink shared channel (PUSCH) in the second operation mode.
